(19) United States
(12) Patent Application Publication
(10) Pub. No.: US 2021/0372920 A1
(43) Pub. Date: Dec. 2, 2021

(54) HANDHELD NON-CONTACT MULTISPECTRAL MEASUREMENT DEVICE WITH POSITION CORRECTION

(71) Applicants: Peter EHBETS, Zurich (CH); Vitaly DMITRIEV, Regensdorf (CH); Heiko GROSS, Beringen (CH); Johannes RILK, Jena (DE); Thomas HOEPPLER, Jena (DE); David GAMPERL, Premstaetten (AT)

(72) Inventors: Peter EHBETS, Zurich (CH); Vitaly DMITRIEV, Regensdorf (CH); Heiko GROSS, Beringen (CH); Johannes RILK, Jena (DE); Thomas HOEPPLER, Jena (DE); David GAMPERL, Premstaetten (AT)

(21) Appl. No.: 17/053,018

(22) PCT Filed: May 6, 2019
(86) PCT No.: PCT/EP2019/061521

§ 371 Date: Nov. 4, 2020

Related U.S. Application Data
(60) Provisional application No. 62/667,018, filed on May 4, 2018.

(51) Int. Cl. G01N 21/3581; G01N 21/33

(52) U.S. Cl. CPC G01N 21/3581; H04W 88/02; G01N 21/33

(57) ABSTRACT

A non-contact multispectral measurement device for measuring reflectance properties of a surface of interest may include a multispectral measurement system, a position measurement system for measuring position values of the multispectral measurement system relative to the surface of interest, and means to correct multispectral values from the multispectral measurement system based on detected position values from the position measurement system. In some embodiments the multispectral measurement system is configured with a retro-reflection measurement geometry, where the illumination light path and observation light path are inclined with respect to a surface normal of the surface of interest to reduce detection of gloss or surface reflections while obtaining multispectral values. The position measurement system may be selected from the group consisting of: a pattern projector and a camera, a camera autofocus system, a stereo vision system, a laser range finder, and a time of flight distance sensor.

### BACKGROUND

Color measurement as part of a workflow has traditionally been performed with contact mode color measurement instruments. Examples are the “Capsure” instrument from X-Rite Inc. The Capsure instrument includes an integrated display and is capable of standalone operation. Another example is the color picker instrument “ColorMuse” from Variable Inc. This color picker instrument incorporates basic color measurement functionalities. The color picker instrument communicates over Bluetooth with a smart phone or a tablet which runs a companion software application. These systems are operated in contact mode (i.e., the sample being measured and the instrument are in physical contact). The optical systems of these devices cannot be used for non-contact measurement operation over a large range of positions, ambient illuminations, illumination and pickup spot sizes.

The instruments are based on a 45/0 measurement geometry or a different standard reference measurement geometry such as d/8. In the case of standardized measurement geometries, the measurement distance and the measurement spot size imply restrictions for the minimum mechanical dimensions of the optics. The diameter of the optics scales with increasing measurement distance and/or measurement spot size. A schematic illustration of a known measurement system 10 with illumination in 45° and pick-up in 0° geometry (45/0 geometry) is depicted in FIG. 1. Light source 12 provides illumination, and detector 14 detects light reflected from target surface 16a. The lateral displacement between illumination and pick-up fields as a function of distance variation is shown. With such geometry, the valid range of distance for measurement may be as small as ±2 mm from a target distance d. Also, the mechanical size of the system is impacted by the distance from the measurement system to the sample surface.

Furthermore, changing the distance provides a relative spatial displacement of the observation and illumination fields (shown by the arrows in FIG. 1). The distance range is limited by the condition that a sufficient overlap between the two fields is required. If the distance is too great (illustrated), or too short, the illumination field and the measurement field will not be aligned. For example, target surface 16b, which is spaced from the target distance d by an additional variance v, results in the illumination field to be misaligned with the measurement field.

Non-contact color measurements may also be made. For example, it is known to use the camera embedded in a mobile device to attempt to sample or measure a color of an object. However, cameras typically embedded in mobile devices have limited achievable accuracy and are not appropriate for precise color measurement. The typical RGB color filters are not optimized for color measurement performance. Additionally, environmental measurement conditions are difficult to control.

An improved accuracy may be achieved by using a color reference card. See, for example, U.S. Pat. Pub. 2016/0224861. In this example, a small calibration target is positioned on the sample material to be measured. The calibration target contains known color patches for the color calibration of the camera as well as means to characterize the illumination conditions. However, the achievable accuracy is limited due to availability of only red, green and blue filter functions in the camera. Furthermore, the usability is compromised because it requires the user to carry and place the calibration card on the surface being sampled.

Color sensors for mobile devices also exist, such as the TCS3430 tristimulus sensor from AMS AG. The application for this device is color management of the camera in a mobile device. Such a sensor may be used to assist the smartphone camera sensor with color sensing of ambient light to enhance and improve picture white balance. This sensor has no active illumination. These sensors typically require no specific optical system. An optical diffuser in front of the active detector area is sufficient. However, even with correction for ambient lighting conditions, limitations still exist for the RGB camera.

U.S. Pat. No. 8,423,080 describes a mobile communication system including a color sensor for color measurement. The usability of this system is limited since it requires manual positioning of the sensor at a pre-defined distance to initiate the automatic execution of a measurement. Controlling and holding the mobile communication device with the sensor at a pre-defined distance can be difficult. Additionally, the system is limited to color data and does not support spectral reflectance information of the sample. This limits the flexibility to use the data in an open system architecture with different data libraries requiring different colorimetric calibration settings and search parameters.

An additional attempt at measuring color with a mobile phone is U.S. Pat. No. 9,316,539. This patent describes a compact Fourier transform spectrometer that can operate with fringe generating optics and the camera sensor of the mobile phone. Such an arrangement does not offer the possibility to use the camera for targeting and positioning with respect to the spectral color measurement.

### SUMMARY

The present invention comprises a non-contact spectral measurement system comprising a retro-reflection multispectral sensing system and a position correction system. The combination of these systems, in addition to calibration information, allows for non-contact measurement over a relatively wide range of measurement distances and for correction of sensor distance and angle with respect to a surface being measured. This enables accurate spectral measurement in the visible spectral region from 400 to 700 nm wavelength range, which may be extended to cover the UV (below 400 nm) and Near Infra-red (NIR) (over 700 nm) spectral regions. The non-contact spectral measurement system may be advantageously included on handheld measurement devices. The system may also be included on mobile communications devices to improve their spectral measurement capabilities. “Non-contact multispectral measurement device,” as used herein, includes but is not limited to dedicated hand held devices and other mobile devices, such as smart phones and tablets.

A non-contact multispectral measurement device for measuring reflectance properties of a surface of interest may include a multispectral measurement system, a position measurement system for measuring position values of the multispectral measurement system relative to the surface of interest, and means to correct multispectral values from the multispectral measurement system based on detected position values from the position measurement system. In some embodiments the multispectral measurement system is configured with a retro-reflection measurement geometry, where the illumination light path and observation light path are inclined with respect to a surface normal of the surface of interest to reduce detection of gloss or surface reflections while obtaining multispectral values. The reflectance properties may be measured to determine visible color properties of the surface of interest, but the invention is not so limited.

The position measurement system may be selected from the group consisting of: a pattern projector and a camera, a camera autofocus system, a stereo vision system, a laser range finder, and a time of flight distance sensor.

The detected position values may include at least a distance and an orientation angle of the multispectral measurement system relative to the surface of interest. The position measurement system may include a camera and/or a display to assist in targeting of a measurement area on the surface of interest.

The observation light path may be inclined from the surface normal by at least 15 degrees, 20 degrees or more. In one embodiment, the observation light path angle is inclined from the surface normal by approximately 22.5 degrees.

The observation light path and the surface normal may be considered to define a plane of incidence, and the illumination light path, when projected onto the plane of incidence, is inclined with respect to the surface normal at an angle that differs from the observation light path's angle by less than 10 degrees, or less than 5 degrees.

The multispectral measurement system may comprise at least one illumination source, a multispectral detector, and optics coupled to the illumination source and to the multispectral detector to provide the retro-reflection measurement geometry, wherein the observation light path and the surface normal define a plane of incidence, and the at least one illumination source is located offset from the multispectral detector and on a line that is substantially perpendicular to the plane of incidence. The observation light path and the illumination path may be inclined from the surface normal by between 20 and 30 degrees, between 20 and 25 degrees, or in one example, by approximately 22.5 degrees. The at least one illumination source may be a non-collimated illumination source. The optics may provide a divergent optical ray observation light path and a divergent optical ray illumination light path. The optics may comprise at least one lens and a folded light path.

The at least one illumination source may comprise at least a first illumination source and a second illumination source, the first and second illumination sources being located on opposite sides of the multispectral detector and on a line that passes through the multispectral detector and that is substantially perpendicular to the plane of incidence.

The multispectral values may comprise at least six channels of spectral information. The multispectral measurement system may comprise a multispectral detector capable of measuring at least six channels of spectral information, and the multispectral values may comprise at least six channels of spectral information.

The at least one illumination source may emit radiation over a range of visible light, infra-red non-visible light, and ultraviolet non-visible light, and any combination thereof, and the multispectral data may comprise spectral information over the same ranges and sub-ranges.

The non-contact multispectral measurement device may comprise a mobile communications device. The non-contact multispectral measurement device may comprise a dedicated color measurement device.

The means to correct values output from the multispectral measurement system based on values provided by the position measurement system may include a processor configured with instructions stored in a non-volatile memory that, when executed, cause the non-contact multispectral measurement device to operate the position measurement system to obtain a distance and an angular orientation of the multispectral measurement system with respect to the surface of interest, operate the multispectral measurement system to acquire multispectral data corresponding to the surface of interest, and correct the acquired multispectral data for the distance and orientation of the multispectral measurement system with respect to the surface of interest to produce position-corrected multispectral data.

In another example, a non-contact multispectral measurement device is provided for measuring reflectance properties of a surface of interest, where the surface of interest corresponds to a use case of surfaces having similar reflective properties. Such a device may comprise any or all of the non-contact multispectral measurement devices disclosed or described herein and having a multispectral measurement system configured with a measurement path geometry having an illumination light path and an observation light path, a position measurement system, a data store, storing at least one set of use case calibration parameters and distance and orientation correction parameters, and a processor, in communication with the multispectral measurement system, the position measurement system, and the data store. In some embodiments, the measurement path is a retro-reflector measurement path inclined from the surface of interest to reduce gloss or surface reflection effects from the surface of the interest. The processor may be configured with instructions stored in a non-volatile memory that, when executed, cause the multispectral measurement device to operate the position measurement system to obtain a distance and an angular orientation of the multispectral sensor with respect to the surface of interest, operate the multispectral measurement system to acquire multispectral data corresponding to the surface of interest, retrieve distance and orientation correction parameters from the data store and correct the acquired multispectral data for the distance and orientation to produce position-corrected multispectral data, and retrieve use case calibration parameters from the data store and correct the position-corrected multispectral data to produce corrected multispectral data.

The position measurement system may further comprise a camera and a display in communication with the processor, wherein the processor is further configured with instructions that, when executed, cause the processor to display positioning guidance to a user based on the obtained distance and an angular orientation of the multispectral sensor with respect to the surface of interest and the field of view of the camera. The instructions may be stored in a non-volatile memory. The positioning guidance may comprise displaying a virtual measurement point on an image of the surface of interest acquired by the camera. The non-contact multispectral measurement device may further comprise the process of determining that the obtained distance and angular orientation multispectral measurement system are within a correctable range of distance and angular orientation before operating the multispectral measurement system.

The position measurement system may comprise a pattern projector and a camera, and the data store may further store calibration parameters for the pattern projector and camera. The pattern projector may project a plurality of position markers, and wherein the processor is further configured with instructions that, when executed, cause the camera to acquire an image including the position markers as projected on the surface of interest, and the processor processes the image to determine a distance and angle of a plane defined by the position markers relative to the camera and pattern projector. The processor may also process the image to determine a three-dimensional shape of the measurement area.

The processor may be further configured with instructions that, when executed operate the multispectral measurement system to acquire a plurality of multispectral measurements of the surface of interest. The plurality of multispectral measurements of the surface of interest may comprise at least one measurement with illumination from an illumination source and at least one measurement under ambient lighting conditions. The processor may be further configured with instructions that, when executed, use the at least one measurement under ambient lighting conditions to correct the least one measurement made with illumination from an illumination source.

The processor may be further configured with instructions that, when executed, cause the processor to obtain ambient lighting conditions from the camera and correct the acquired multispectral data for ambient lighting conditions. The processor may be further configured with instructions that, when executed, cause the processor to correct the acquired multispectral data for ambient lighting conditions prior to correcting for distance and orientation to the surface of interest.

Producing position-corrected multispectral data may further comprise configuring the processor to retrieve distance correction parameters from the data store and correct the acquired multispectral data for the measured distance to the surface of interest to produce distance corrected multispectral data, and retrieve orientation correction parameters from the data store and correct the distance corrected multispectral for orientation to produce position-corrected multispectral data. The use case correction parameters may comprise a plurality of sets of use case correction parameters, each set of use case correction parameters corresponding to a different type of surface to be measured. The different types of surfaces comprise at least two of textile surfaces, architectural paint surfaces, automotive coating surfaces, human skin and plastic surfaces.

The illumination light path may be inclined with respect to the surface normal within about 5 degrees of the observation light path. The illumination light path and the observation light path may be inclined with respect to the surface normal by at least 15 degrees.

The distance and orientation correction parameters may include pre-determined distance correction coefficients, and distance correction is executed on the acquired multispectral by a correction polynomial using the pre-determined coefficients. The distance and orientation correction parameters may also include bidirectional reflectance distribution function (BRDF) parameters approximating the reflection characteristics of the measurement surface. The distance and orientation correction parameters include a predetermined bidirectional reflectance distribution function (BRDF) model and BRDF parameters and the correction of the acquired multispectral data for distance and orientation to produce position-corrected multispectral data includes fitting the parameters of a predetermined BRDF model approximating the reflection characteristics of the measurement surface. The BRDF model may comprise an Oren-Nayar model.

The non-contact multispectral measurement device may further comprise a camera, wherein the processor is further configuring to operate the camera to obtain an image of the surface of interest and derive a bidirectional reflectance distribution function (BRDF) model and BRDF parameters from the image of the surface of interest. The correction of the acquired multispectral data for distance and orientation to produce position-corrected multispectral data may include fitting the parameters of a derived BRDF model approximating the reflection characteristics of the measurement surface. The image of the surface of interest may be acquired by the camera with an off-axis illumination.

A method of generating correction parameters for measuring multispectral properties of a type of surface to be measured for use with any or all of the non-contact multispectral measurement devices disclosed or described herein may comprise measuring multispectral properties of a plurality of sample surfaces representative of the type of surface to be measured with a reference device to generate use case baseline parameters; measuring multispectral properties of the same or similar sample surfaces with a characterization device representative of a specific combination of optical measurement geometry, multi-spectral detector and illumination source; comparing the measurements with the use case baseline parameters to generate use case transfer parameters; generating unit-specific transfer parameters for an individual unit in production having a combination of optical measurement geometry, multi-spectral detector and illumination source that is substantially the same as the characterization device; combining the unit-specific transfer parameters with the use case transfer parameters to generate use case and device specific color calibration and correction parameters; and providing the use case and device specific color correction parameters to a non-contact multispectral measurement device. The type of surface to be measured may include textiles, printed paper, architectural paints, automotive coatings, skin, plastics or additional surface types.

The multispectral properties may be obtained at varying angles and distances with respect to the plurality of sample surfaces. The reference device and the characterization device do not necessarily have the same combination of optical measurement geometry, multi-spectral detector and illumination source.

The step of generating unit-specific transfer parameters for an individual unit in production may further comprise measuring reflectance properties of neutral targets with the individual unit in production. The step of generating unit-specific transfer parameters for an individual unit in production may further comprises identifying multispectral detector filter curves and illumination spectra of the individual unit in production. The step of generating unit-specific transfer parameters for an individual unit in production further comprises measuring multispectral properties of the same or similar sample surfaces with the individual unit in production.

### BRIEF DESCRIPTION OF THE DRAWINGS

FIG. 1 is a schematic illustration of an example of known 45/0 measurement geometry.

FIG. 2 is a block diagram of an example of a non-contact multispectral measurement device according to the present invention.

FIG. 3 is a schematic illustration of an example of a retro-reflection measurement system according to one aspect of the present invention.

FIG. 4 is a schematic illustration of an example of a retro-reflection measurement system including a camera according to another aspect of the present invention.

FIG. 5 is a schematic illustration including fields of illumination and view of an example of a retro-reflection measurement system including a camera according to another aspect of the present invention.

FIG. 6 is graph of response values provided by a retro-reflection measurement system at target distance to a measured surface and at target distance ±5 mm to a measured surface.

FIG. 7 is a graph showing ratios of response values of provided by a retro-reflection measurement system at distances of target distance +5 mm and target distance −5 mm to a measured surface relative to response values at the target distance to a measured surface.

FIG. 8 is a graph of filter functions for a multispectral detector which may be used in implementing the present invention.

FIG. 9 is an example of a photodiode layout for a multispectral detector which may be used in implementing the present invention.

FIGS. 10 and 11 illustrate examples of optical designs which may be used in implementing the present invention.

FIG. 12 illustrates an example of a folded light path optical design which may be used in implementing the present invention.

FIGS. 13 and 14 illustrate examples of spatial relationships between illumination sources and a multispectral detector according to examples of a multispectral measurement system according to another aspect the present invention.

FIG. 15 illustrates an example of spatial relationship between an illumination path and an observation path with respect to a surface being measured according to another aspect of the present invention.

FIG. 16 is a flow chart illustrating steps for calibrating and using a position detection system which may be used in implementing a retro-reflection measurement system according to another aspect of the present invention.

FIG. 17 illustrates an example of dot pattern projection which may be implemented to determine position and angle information.

FIG. 18 illustrates an example of dot pattern detection which may be implemented to determine position and angle information.

FIG. 19 illustrates calibration procedures for generating use case calibration parameters and multispectral device calibration parameters according to another aspect of the present invention.

FIGS. 20a and 20b illustrate examples of measurement processes relative to time using a retro-reflection measurement system according to another aspect of the present invention.

FIG. 21 illustrates an example of a logical flow chart for a measurement process using a retro-reflection measurement system according to another aspect of the present invention.

FIG. 22 illustrates an example of a data flow chart for a measurement process using a retro-reflection measurement system according to another aspect of the present invention.

FIG. 23 illustrates an example of a setup for determining distance and angular position correction parameters for a retro-reflection measurement system according to another aspect of the present invention.

FIG. 24 is a graph illustrating a response curve for a multispectral detector as distance to a surface being measured varies.

FIG. 25 is an example of using live-view feedback from a position sensor to assist a user in targeting a sample surface which may be used with a retro-reflection measurement system according to another aspect of the present invention.

FIGS. 26 and 27 are examples of using visual feedback to assist a user in targeting a sample surface which may be used with a retro-reflection measurement system according to the present invention.

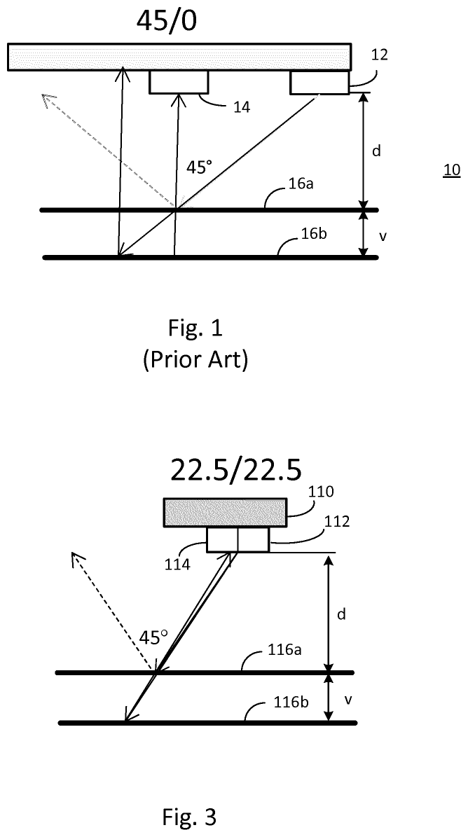

### DETAILED DESCRIPTION

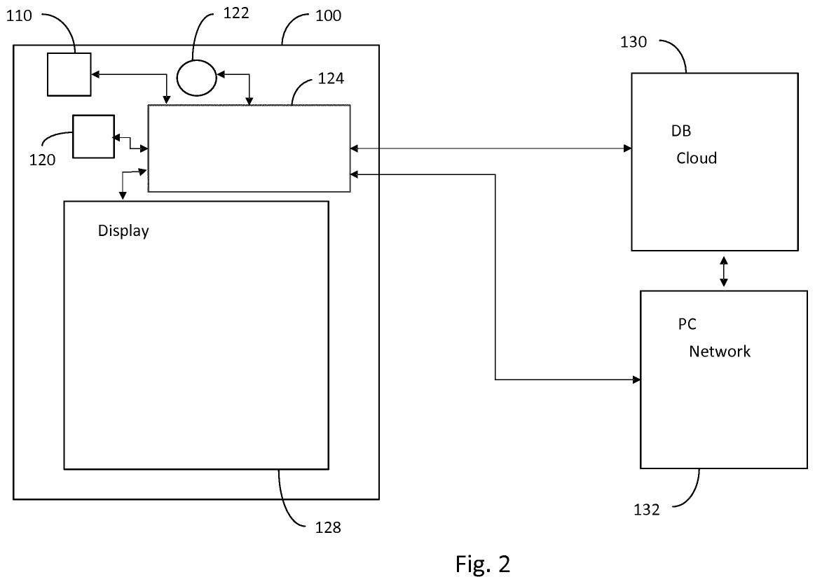

With reference to FIG. 2, a block diagram of a non-contact multispectral measurement device 100 is provided. The non-contact multispectral measurement device 100 may be implemented on mobile communications systems or dedicated handheld measurement devices. Mobile communications systems, such mobile smartphones or tablets, typically include mobile phone electronics, an operating system (such as iOS or Android), a camera, a display, data input capabilities, memory for data storage, and an interface to external systems (cloud, pc, networks) and wireless communications systems, such as cellular voice and data systems, LTE systems, and other wireless communications systems. Such mobile communications systems are referred to herein as “mobile devices.”

A non-contact multispectral measurement device 100 may comprise a retro-reflection multispectral measurement system 110, a position correction system 120, and application software and calibration data processed by processor 124. The application software and calibration data may be stored in a non-volatile memory. A RGB camera 122 and a display 128 may also be provided. As described more fully herein, the measurement geometry of the retro-reflection measurement optics, and the distance and angular orientation guidance and correction provided by the present invention improves ease of use and spectral accuracy by making accurate measurements over a wider range of distances and orientations than was previously known. The application software runs on the non-contact multispectral measurement device 100 and controls the data acquisition workflow, the user interaction and the processing of the data and the application. The additional sensor components can be realized in the non-contact multispectral measurement device 100 or attached to the outside of the housing of the non-contact multispectral measurement device 100. The non-contact multispectral measurement systems described herein are not limited in use to mobile systems, and may be included in any device where non-contact spectral measurement with distance and angle correction is desired, including being embedded in industrial systems.

A non-contact multispectral measurement device 100 with spectral sensing capabilities of the present invention is particularly well suited to measure an “inspiration color” found on a surface of an object due to its ease of use, targeting assistance and use of correction parameters. Having accurately captured the inspiration color, the software application may identify a matching color in a database 130 of digital reference data corresponding to a set of color shades. A color database, as that term is used herein, may include relational databases, flat files of structured data (e.g., CxF and AxF files) and other libraries of structured data comprising spectral or other color data (RGB, CIE tristimulus colors, etc.) and/or associated metadata pertinent to a given use case (scattering parameters, effect finishes, translucency, printing conditions, etc.). Each different color database may have different classes of materials and measurement requirements and therefore requires different calibration parameters. Such databases having different calibration parameters would be considered different use cases. Color databases may include, for example, PANTONE Color Matching System colors, printable color, architectural paint color databases, plastics colors databases, skin tone databases, and the like. The database 130 may be stored on the non-contact multispectral measurement device 100 or be cloud based and accessed using a mobile device's communications capabilities, either directly or through a computer network 132 as shown in FIG. 2.

Referring to FIG. 3, the multispectral measurement system 110 includes a retro-reflection measurement path comprising an illumination light path and an observation light path, one or more sources of illumination 112 and a multispectral detector 114. The illumination sources 112 and multispectral sensor 114 may be separately mounted or positioned on a single circuit board or substrate, along with electronics and embedded firmware to operate the sensor according to a measurement sequence and to interface the measurement data to the application software. Preferably, the multispectral measurement system 110 is miniaturized and has a form factor suitable for integration into a mobile device or dedicated handheld measurement device. Additionally, the multispectral measurement system 110 is preferably adapted to extend valid non-contact measurement distance ranges to ±10 mm, ±20 mm, or more, relative to a target measurement distance.

According to one aspect of the present invention, the geometry of the retro-reflection measurement path may be configured to provide standardized aspecular measurement angles. One standard measurement geometry for color measurement (CIE publication 15, 2004) is based on an illumination angle of 45° and a detection angle of 0°, and is commonly referred to as 45/0 measurement geometry. This measurement geometry provides an aspecular angle of measurement, which is defined as the angular difference between the direction of specular reflection of the illumination in the center of the observation field and the corresponding observation angle at the center field position. The aspecular angle is a relevant parameter for the amplitude of the surface reflection radiation. The 45/0 measurement geometry has an aspecular angle of 45°.

As shown in FIG. 3, an exemplary implementation of a multispectral measurement system 110 according to the present invention has measurement path with a 22.5° illumination angle and a back-reflected 22.5° detection angle in the plane of incidence with respect to a surface normal. This provides an aspecular measurement angle of 45° in the plane of incidence with respect to the specular surface reflection, which corresponds to the standardized 45/0 measurement geometry. Selecting the same aspecular angles is helpful because the surface reflections are of comparable size to the standard 45/0 measurement geometry. This selection can be useful if at a later stage the measurement data of the current system needs to be compared to the measurement data of an instrument with a 45/0 geometry. This conversion can be achieved with an algorithmic correction of the measurement results.

In this retro-reflection measurement geometry, the illumination sources 112 and the multispectral detector 114 components of the multispectral measurement system 110 project light onto the sample and receive back-reflected light from the sample at the substantially the same angle with respect to a surface normal of the surface being measured. The illumination and detection angles are not necessarily precisely equal, because locating an illumination source 112 adjacent to a multispectral pick-up detector 114 may result in some minor difference between the illumination and detection angles. Accordingly, receiving back-reflected optical radiation at the same or at least substantially the same angle (e.g., typically within about ±5° in the plane of incidence) (FIG. 15) as the illumination optical radiation is referred to herein as retro-reflection measurement geometry. Differences in angles outside of the plane of incidence have less effect on measurement accuracy, and need not be within ±5° to be considered retro-reflection measurement geometry (FIG. 14).

With a retro-reflection measurement geometry, the mechanical size of the multispectral measurement system 110 may be very compact, since the illumination and detector components may be arranged at the same location on a small area such as on a common socket or support part. Additionally, the illumination and observation light paths stay centered with respect to each other when the measurement distance varies. The illumination and observation light rays are substantially collinear in the plane of incidence as shown in FIG. 3. This allows the field of illumination and field of observation to maintain alignment over a large measurement distance and accurate operation over a relatively large range of distance variations. For example, in FIG. 3, the field of illumination and field of observation remained aligned on target surface 116a, spaced distance d from the multispectral measurement system 110, and on target surface 116b, spaced distance d+v from the multispectral measurement system 110.

Certain applications may require care in choosing the central incidence angle of the illumination and observation optical paths. If the sample surface has some roughness or structure, the reflected radiation from the surface will impact the measurement results. The color of the sample may be characterized by the material properties inside the material (e.g., sub-surface scattering). The radiation from the surface is superimposed on the sub-surface radiation and perturbs the measurement results. Larger aspecular angles relative to the measurement surface reduce the corresponding surface effects from rough surfaces. Accordingly, the present invention is not limited to the specific 22.5° retro-reflection angles illustrated in the figures. Any aspecular angle larger or equal than 30°, or more preferably 40° may be appropriate, depending on the surfaces to be measured. These aspecular angles result in retro-reflection angles larger or equal than 15°, or more preferably 20°. An alternative example would be an 30°/30° optical system which corresponds to an aspecular angle of 60°. The retro-reflection angles may by in the range of 15° to 30°.

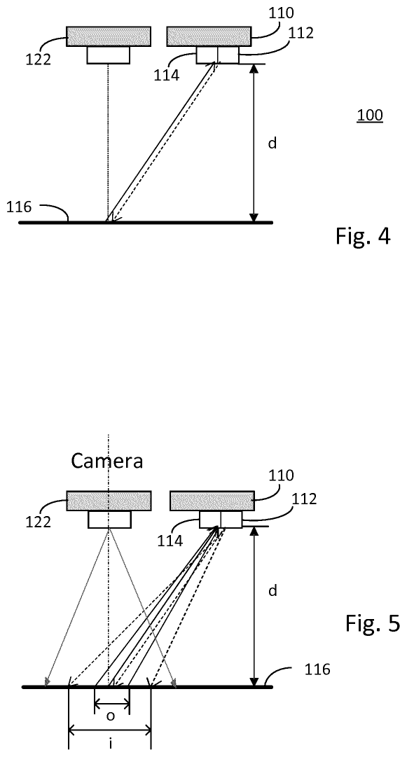

When it is desired to acquire images of the target surface during spectral measurement operations, the design of the multispectral measurement system 110 may be defined for a pre-defined target measurement distance as schematically shown in FIG. 4. In FIG. 4, the position of the multispectral measurement system 110 with respect to the camera 122 in the non-contact multispectral measurement device 100 is shown. In this example, the center of the measurement field at the pre-defined target measurement distance d is positioned at the intersection point with the optical axis of the camera 122.

The target measurement distance to the measurement plane should be selected so that the camera can achieve a sharp image of the sample at this distance and over the desired distance variation range. A reasonable pre-defined target measurement distance d is in the range of 30 mm to 150 mm. Any other distance could equivalently be supported by an adapted design.

The multispectral measurement system 110 should generate accurate measurement results for a broad range of materials. Many materials are not homogenous. Accordingly, the size of the observation field of the detector pick-up optics may be selected to be sufficiently large with respect to the surface inhomogeneities in order to provide a representative average measurement result. Referring to FIG. 5, a typical observation field size o with a diameter in the range of 6 to 12 mm at the target measurement distance has been found to be appropriate. The present invention is not limited to any particular size of observation field. The illumination field is selected to over-illuminate the observation field of the multispectral pick-up detector. Over-illumination, in this context, refers to the size i of the illumination field relative to the observation field, where i is greater than o, and not to the intensity of the illumination. In some applications, an over-illumination radius of 2 mm at the target measurement distance may be appropriate. Depending on the translucency properties of the material the over-illumination radius may need to be increased. For translucent media like human skin the over-illumination radius should be in the range of 4 mm to 10 mm or higher. The present invention is not limited to any particular range of over-illumination radius.

The desired field size m in the measurement plane (6-12 mm) is bigger than the desired package size of the full multispectral measurement system. A measurement system with a miniature multispectral detector in the range of few millimeters will require diverging optical beams for the illumination and detector observation optical systems. The solid light bundle is the observation beam; the dashed light bundle corresponds to the illumination beam.

A consequence of the optical design with a diverging illumination beam is that the detected optical signal varies as the distance and angular orientation with respect to the measured surface varies. For example, the area of the illumination field and observation field will increase with increasing measurement distances. The present invention includes a position correction system that provides information on the effective distance and angular orientation of the sample with respect to the multispectral measurement system. This position/orientation information is used by correction algorithms that correct the measurement results as a function of distance and angle with respect to the target reference measurement geometry. The position correction system may also be used in combination with the display of the non-contact multispectral measurement device 100 to provide guidance to the user to hold the non-contact multispectral measurement device 100 at an appropriate distance and angle with respect to the measured surface.

The retro-reflection measurement geometry of the multispectral measurement system 110 is well suited for such algorithmic position correction. The optical design has the property that over a large distance variation range the resulting relative signal variation is the same for each spectral observation channel of the multispectral detector 114. The distance correction can be described by a global relation between measurement signal and distance variation valid for all spectral filter channels.

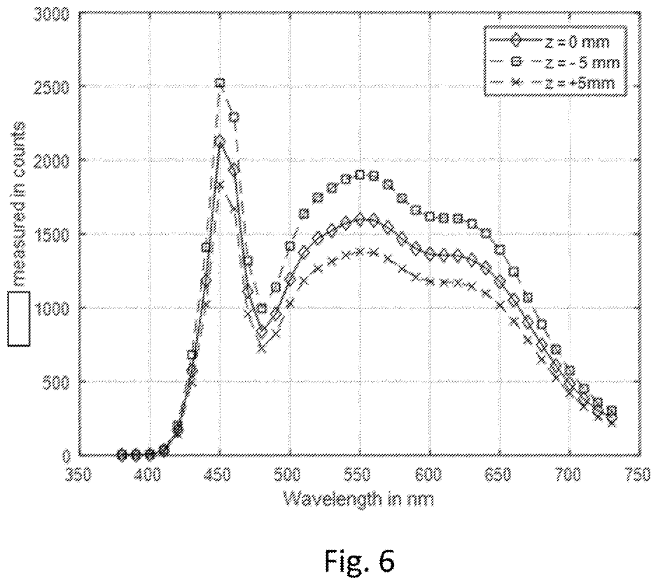

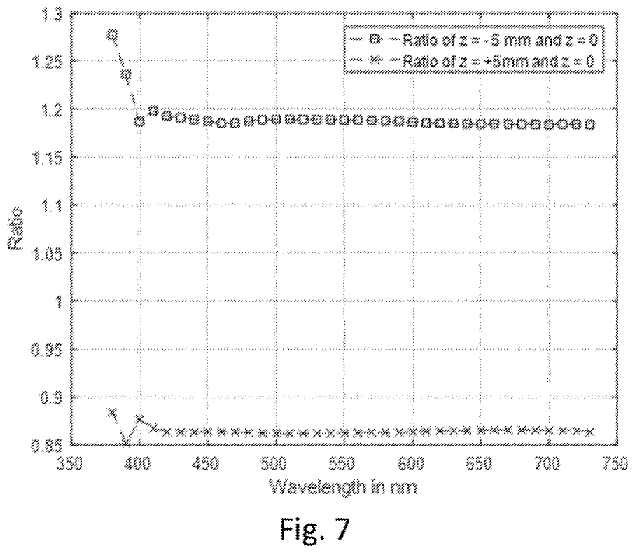

This behavior can be characterized in the laboratory on a set of representative prototypes. A typical measurement result is shown in FIG. 6 shows response of the multispectral detector at a target distance, at the target distance +5 mm, and at the target distance −5 mm. FIG. 7 shows the comparison of target distance to the +5 mm and target to −5 mm distances. The figure represents the relative signal variation of the illumination over a distance range of +/−5 mm with respect to the target distance. It can be seen that the relative ratio curves are constant over the full illumination wavelength range (400 to 700 nm).

The multispectral detector 114 in the multispectral measurement system 110 may comprise a CMOS detector with a photodiode array. Multispectral in this context means six or more different spectral channels, where each channel corresponds to a bandwidth of optical radiation. Optical radiation includes visible, ultraviolet and infrared radiation. An example of a commercially available six channel array is the AS7262 multispectral sensor, available from AMS AG. It is possible to apply more channels in the range of 16 or more. In this case the capabilities would correspond to a hyper-spectral or full spectral measurement system.

In a multispectral CMOS photodiode array, a precision spectral bandpass filter is deposited on each photodiode. The filters may be realized by thin film coating technology in combination with photolithographic techniques to achieve the spatial microscopic filter pattern. The present invention is not limited to CMOS photo-diode arrays. Alternative photosensitive detector array technology may be applied.

The spectral filters pass selected wavelengths of light to enable the spectral analysis. Color measurement requires spectral analysis over the visible wavelength region. The number of spectral filters, the center wavelength of each filters, the bandpass (the full width at half maximum of the filter function) as well as the shape of the filter function have an impact on the achievable performance.

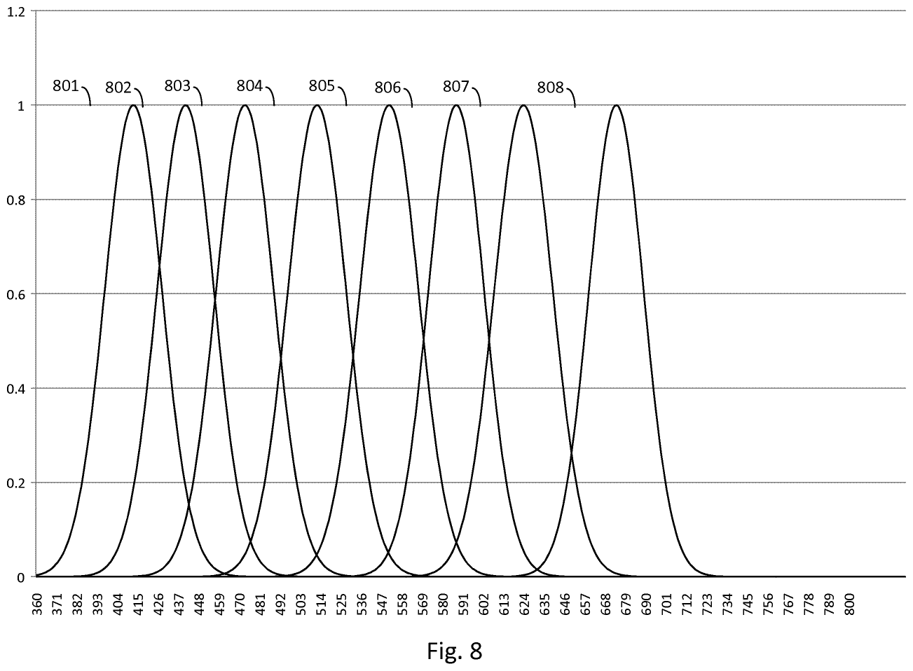

FIG. 8 shows an example of a filter set composed of eight filter bandpass functions 801-808, respectively, selected to cover the visible range of light. Greater or fewer channels may be used. Spectral filters in the UV range below 400 nm and in the NIR range over 700 nm may also be included. The filters should continuously sample the specified spectral measurement range without gaps. The spectral measurement range for color application is typically the visible spectral range from 400 to 700 nm. The spectral filters may cover the full sensitivity region of the underlying photodiode.

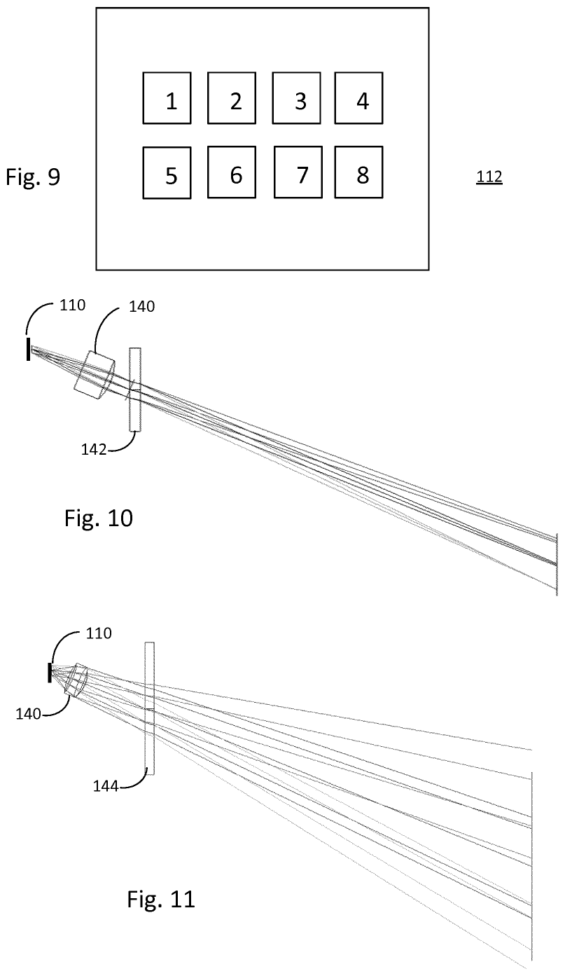

An example of a CMOS detector array is provided in FIG. 9. FIG. 9 illustrates a conventional eight channel array. The numerals 1-8 in FIG. 9 correspond to filter functions 801-808, as illustrated in FIG. 8. A sensor having multiple sets of photodiodes arranged in a periodic array may also be suitable. A photodiode array with complementary symmetrically-located detector photodiodes may also be employed. A complementary, symmetrical arrangement of photodiodes allows for compensation of variations of the measurement results due to different observation angles of the individual photodiodes in the matrix. Adding the signals of the corresponding detector pixels with the same spectral filter in the detector readout electronics will cancel the measurement effect due to different observation angles.

It may also be advantageous to calculate the difference between the two photodiode locations having the same filter function. The difference signal may be divided by the distance between the two filter locations on the photodiode array. This provides information about the angular variation of the measurement signal for each filter wavelength. The result of this operation is a spectral vector with additional information about the angular behavior of the material. This additional information may be used to refine the search in the color libraries or databases.

The multispectral detector chip may be placed in a compact chip package. The observation field of the detector is defined by additional optical means like a lens or lenses, apertures or lamellar structures. These optical elements may be integrated with the detector package for a miniaturized solution or externally arranged in the mechanical housing of the multispectral measurement system. An additional diffuser may be included between the detector pixels and the optical components for shaping of the observation field. The additional diffuser helps to average out measurement effects due to different viewing angles and inhomogeneities of the sample.

FIG. 10 shows one example of an implementation of the multispectral color detector pick-up optical design with external lens 140 and an aperture 142 to define the illumination light bundle. The lens is at a 22.5 angle with respect to the multispectral detector to create the desired retro-reflective measurement geometry. While only three paths of light corresponding to different photodiodes on a multispectral detector are illustrated for purposes of clarity, the invention is not so limited. The optics for the illumination system for the shaping of the illumination beams may comprise mechanical apertures, lenses or lamellar structures to define the illumination cone angle. FIG. 11 provides an example of an optical detector pickup system with an external lens 140 and mechanical aperture 144 to shape the light bundle. The multispectral measurement system 110 may be integrated inside a mobile device or may be attached outside to the casing of the mobile device.

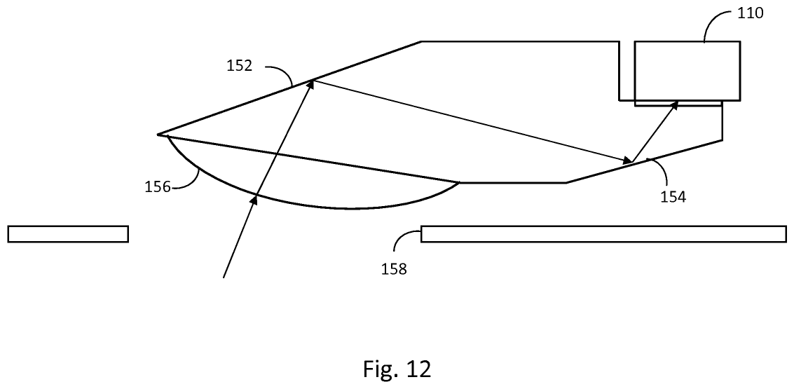

FIG. 12 presents another example of an optical design 150 comprising a folded optical path for the illumination and detection optical systems suitable for use in the present invention. The folding of the optical path can be achieved by one, two or more surface reflections. Although a multispectral measurement system 110 is illustrated in FIG. 12, a discrete multispectral detector 114 or illumination source(s) 112 may be substituted therefore. In some embodiments an optical diffuser can be arranged between the exit surface of the multispectral measurement system 110 and the optical system. In the particular optical system shown in FIG. 12 the light path is folded by two surface reflections 152, 154 followed by a lens 156. Alternative embodiments may implement a different number of surface reflections. The lens function may be realized by one or multiple surfaces of spherical or aspherical shape. In alternative embodiments, the lens function may be realized with the reflecting surfaces, that is, the reflecting surfaces may be surfaces with curvature instead of being planar. In an optical design, the lens function may be realized by a Fresnel lens. In a specific embodiment the surface reflections and the lens are formed in a single component. The optical component may be composed of a transparent material such as glass or polymer. FIG. 12 shows an aperture 158 after the lens surface. The optical ray path and ray pattern after the aperture towards the sample plane corresponds to the geometries shown in FIGS. 10 and 11.

The illumination sources 112 for the multispectral measurement system 110 may comprise, but are not limited to, light emitting diode (LED) emitters. Any suitable lamp or emitter may be used. The illumination sources 112 are placed in close proximity to the multispectral detector 114 optics. The illumination sources 112 may be integrated in the same package as the multispectral detector 114. White LEDs may be used for making measurements in the visible spectrum. For an extension of the spectral range, UV LEDs and NIR LEDs may be added. In addition, the white LEDs may be supplemented with additional LEDs having a narrower spectrum in the visible region.

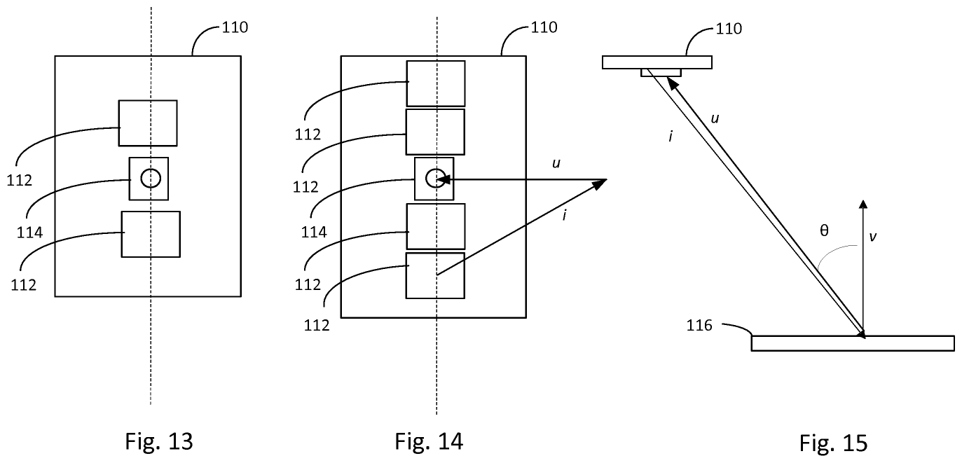

Examples of placement of the illumination sources 112 with respect to the multispectral detector 114 are shown in FIGS. 13 and 14. Two illumination sources 112 are symmetrically arranged about the multispectral detector 114 in FIG. 13. In FIG. 14, four illumination sources 112 are illustrated with respect to the multispectral detector in the center.

Referring to FIG. 15, the plane of incidence is defined by the central observation path of the multispectral detector (vector u) and the normal on the surface of the sample (vector v). As described above, the observation path is inclined from the surface normal by 15° to 30° (angle θ). In a preferred example, the observation direction is inclined from the surface normal by 22.5° Also, to achieve retro-reflection measurement path geometry, the illumination path (vector i), when projected onto the plane of incidence, is inclined from the surface normal by the same, or close to the same, angle as the observation path (typically within 5°). Another optical design goal is for the aspecular angle of the illumination channel of each illumination source 112 is constant with respect to the central observation direction.

Referring to FIGS. 13 and 14, the LEDs on both sides of the multispectral detector are symmetrically arranged in a line perpendicular to the plane of incidence going through the center of the active detector area (dashed line in FIGS. 13 and 14). Due to the small lateral displacement of the LEDs and the detector active area, the observation path and illumination path are not fully co-linear but instead have a small angular deviation. Since the angular deviation is in the out-of-plane direction (perpendicular to the plane of incidence) it has little to no effect on the spectral measurements.

The electronics of the non-contact multispectral measurement device 100 may store information which is useful for the calibration and for the data processing, including spectral data of the filter functions for the detector and the illumination system LEDs, a white reference vector to transfer raw measurement data into calibrated reflectance factor values at the target measurement distance, distance correction polynomial coefficients, and linearity correction.

To support ambient light measurement, an additional Lambertian optical diffusor may be included. The optical diffuser may be mechanically put on the measurement window of the detector pick-up channel. This may be accomplished, for example, with a mechanical slider positioned at the outside of the housing of the non-contact multispectral measurement device 100.

Various means may be employed to provide the non-contact multispectral measurement device 100 with information concerning the distance and angular orientation of a surface to be measured with respect to the multispectral measurement system. For example, “Time of Flight”, “Stereo Vision,” laser measurement, distance sensors, camera auto-focus information, and other means may be implemented. In one advantageous example, a position correction system comprises an optical pattern projector and a camera, such as the camera of a mobile device.

The optical pattern projector may project a set of position markers. In the illustrated examples, the position markers comprise individual dots. Different position markers and patterns are also contemplated, including continuous lines, including rectangles or circular patterns. The optical pattern projector may project visible light in applications where visual guidance for a user is desired. The optical pattern generator may also project non-visible light, such as NIR and UV, in applications where visible light may comprise a distraction or annoyance. Moreover, position markers may be related to position information itself in case when the position sensor uses time of flight or stereovision and searching at projected features on the sample is not needed.

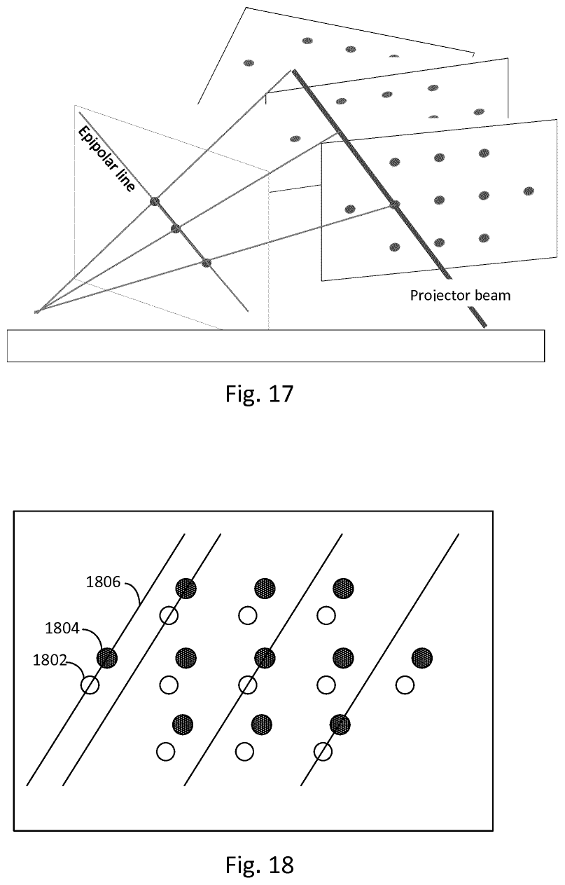

Fitting a set of points by a certain type of surface allows a characterization regarding its position in the given coordinate system. For example, the points might be fit by a plane or a quadric, by the least square methods. For example, FIG. 17 illustrates an example of using epipolar geometry to identify the distance and orientation of three exemplary surface orientations. In FIG. 17, an optical pattern projector is located at a known, fixed distance from a camera. The projector beam projects multiple dots onto a surface of interest. An image of the dots is acquired by the camera. Determining a location of one of the dots along its epipolar line provides 3-D location information for that dot relative to the camera and projector. The determined 3D location of multiple dots may be fitted to a plane, and information concerning the distance and orientation of the plane relative to the camera and projector may be determined. The 3D location of at least three dots is required to define a plane. FIG. 18 is an illustration of dots 1802, 1804 found on Epi-Polar Lines 1806. For purposes of clarity, not all epi-polar lines are illustrated.

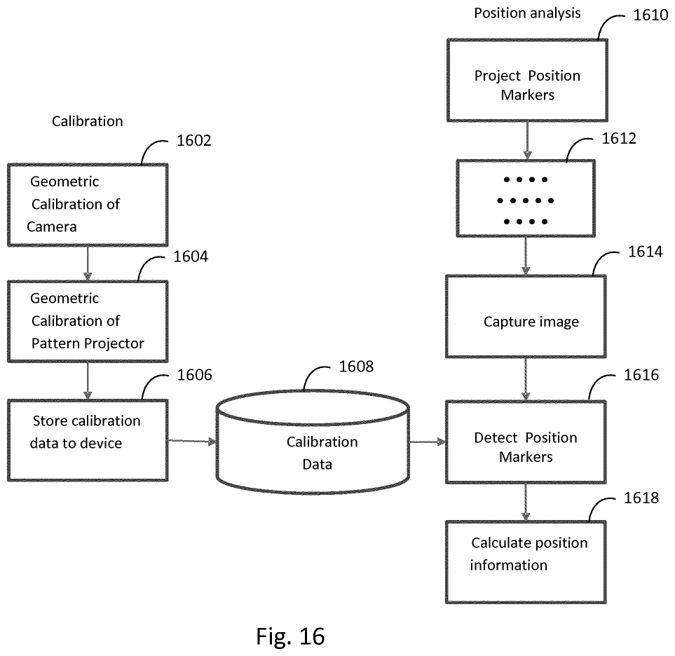

In one example of the present invention, the pattern projector and the camera are in the same non-contact multispectral measurement device 100 and in a in a fixed position relative to each other. The geometry of the system is determined once during production as illustrated in FIG. 16. First the camera geometry is determined in step 1602. The camera may be treated as a pinhole camera. Fixed focus may be used, and a projection matrix called camera matrix is determined. Distortion parameters may also be modeled if necessary. Then the geometry of the pattern projector is determined in step 1604. The light beams from the projector travel in a straight line, so all points where the beam hits a target is also on this straight line. Also, the image of a beam is a straight line which may be referred to as an epi polar line, a common concept of stereoscopy. This, along with the known, fixed distance from the camera to the pattern projector, provides the necessary calibration information for determining the 3-D locations of the projected position markers. In step 1606 the calibration data is stored in a calibration database 1608.

To perform position analysis, position markers are projected on to a surface in steps 1610 and 1612. An image of the position marker is captured in step 1614. Position markers are detected in the image in step 1616 and position information is calculated in step 1618.

The optical pattern generator module should be located near the multispectral measurement system 110 in FIG. 2. It should illuminate the sample from substantially the same direction with a similar incidence angle as the multispectral measurement system 110. Both systems are aligned to be centered on the axis of the camera field at the reference measurement position. This ensures that the light field of the optical pattern generator and the observation field of the detector pick-up channel are overlapping for a large distance variation range. Thus, the distance and orientation angle information are sensed at or near to the same position as the spectral measurements are made.

The distance measurement range of the position correction system is determined by the viewing field of the camera. If the field of view of the camera does not limit either the detector pick-up field or the optical pattern generator field, an analysis of the acquired position and orientation information is followed by a correction of the measurement data. Other restrictions come from the signal level which decreases with increasing distance and from the focusing capability of the camera in the short distance area to provide a sufficiently sharp image for the image analysis.

Calibration data is needed to define algorithms and data parameters for correcting multispectral data produced by the multispectral measurement system. Calibration operates, among others, with the hardware of the multispectral measurement system 110 and with the description of the use case. The use case may be represented as a reference tile collection or as abstract information about their physical properties (e.g. gloss of printed samples). A calibration workflow as presented here assumes that the position correction system has already been calibrated. Output of the calibration includes, but is not limited to:
Calibration data which may be needed to obtain multispectral data from the multispectral detector readings.
Calibration data related to position correction, which may be needed to correct multispectral information based on position correction system.
Calibration data which may be needed to obtain colorimetric or other case dependent data from the multispectral data.

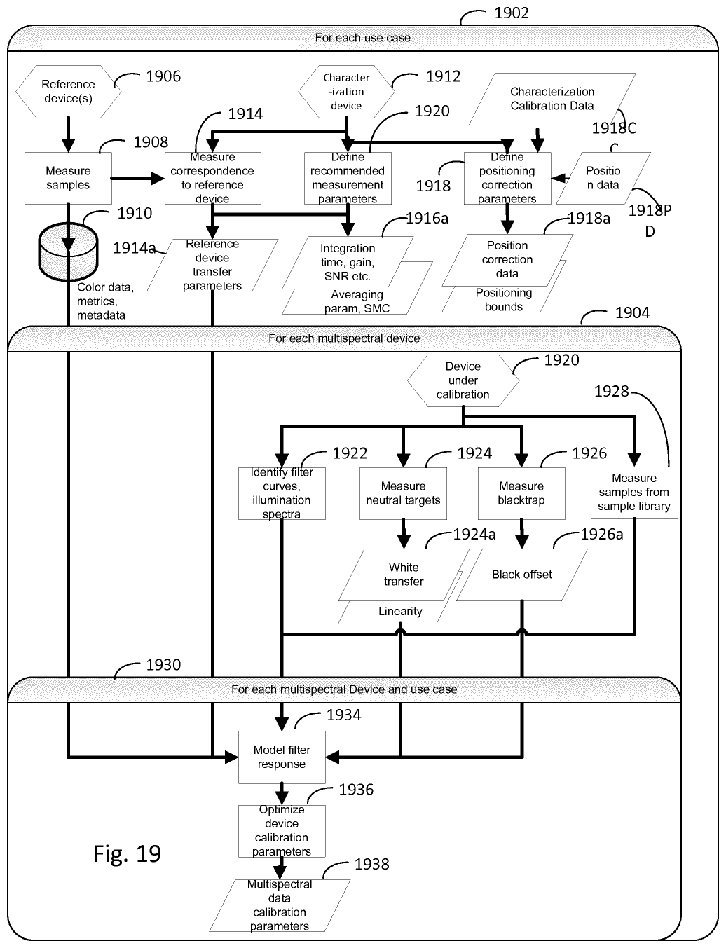

A calibration workflow or method 1900 for the multispectral measurement system 110 is presented in FIG. 19. The non-contact multispectral measurement device 100 may comprise a multispectral measurement system to obtain multispectral data of one or more patches, for example one or more color calibration patches. The one or more color calibration patches may be selected from one or more materials or types of materials.

The multispectral measurement system calibration method 1900 may comprise step 1918 of forming a set of characteristic calibration data 1918CC. The step 1918 may comprise acquiring multispectral data of one or more color calibration patches at one or more reference positions of a reference multispectral measurement system with respect to the one or more color calibration patches. The one or more calibration patches may have one or more colors and be of one or more materials, for example having one or more appearance characteristics. The set of characteristic calibration data 1918CC may be stored on a non-volatile computer-readable memory device. The set of characteristic calibration data 1918CC may be used, for example, on a production line to calibrate and correct the color measurements of one or more multispectral measurement systems of one or more handheld or mobile devices.

The multispectral measurement system calibration method 1900 may comprise a step 1918 of forming a set of position-related color correcting parameters 1918a. The position-related color correcting parameters 1918a may be used for correcting the multispectral data acquired by, for example, a production handheld device comprising a production multispectral measurement system. The data may be acquired at one or more positions, recorded as position data 1918PD, for example positions at which the characteristic calibration data 1918CC may have been acquired. Position data 1918PD may comprise position and orientation measurements of the characterization device 1912, for example position and orientation of one or more of its sensors and illumination sources, with respect to a target, sample, or color calibration patch. The step 1918 may comprise acquiring measurements for a plurality of patches or targets, for example a subset of the patches used for forming the set of characteristic calibration data 1918CC. The position-related color correcting parameters 1918a may be production device- and position-specific. The position-related color correcting parameters 1918a may be stored on a non-volatile computer-readable memory device, for example comprised on the handheld device.

The multispectral measurement system calibration method 1900 may comprise a process 1930 of forming multispectral data calibration parameters 1938 for each spectral device and use case. The multispectral data calibration parameters 1938 may be material- or material type-specific. The multispectral data calibration parameters 1938 may, for example, be represented as one or more matrices, for example a matrix for each material type. For example, material types may be: paper coated with matte ink; paper coated with glossy ink; skin; metallized paint, for example comprising effect pigments; fabric; marble; or a type of polymer. The multispectral data calibration parameters 1938 may be stored on a non-volatile computer-readable memory device, for example comprised on the handheld device.

The step 1930 may comprise using data, for example color data, for example color space data, from one or more measured materials databases 1910. The color space data may, for example be XYZ or L*a*b* data. The step 1930 may comprise acquiring multispectral data of one or more color calibration patches referenced in the materials database 1910, at one or more positions, for example one or more reference positions, using the production device's multispectral measurement system 110 with respect to the one or more color calibration patches. The step 1930 may comprise, for one or more materials or materials type of the materials database 1910, computing a material type-specific minimization 1936 of a sum of colorimetric distances taken over one or more patches of the material database 1910. The colorimetric distance may comprise one or more of: a colorimetric term, for example expressed as a vector of 3 values in an XYZ or an L*a*b* color space; a multispectral data calibration parameters term, for example expressed as a matrix of dimensions 3×8; and a multispectral data term, for example expressed as an array of 8 values corresponding to 8 filter wavelengths of the multispectral detector.

The multispectral data calibration parameters 1938 enable the conversion of a multispectral acquisition using the multispectral measurement system 2200SS of the handheld device into, for example, colorimetric space values. For example, a user may select on the handheld device a type of material the color of which is to be measured, acquire one or more multispectral measurements of a sample or a patch of the material, and obtain, by way of the conversion of the multispectral measurement by the multispectral data calibration parameters 1938, colorimetric space values 2030 for the material. The colorimetric space values 2030 for the material may be searched in the material database 1910 to retrieve a correct color, for example a nearest color match, of the material being measured. The multispectral data calibration parameters 1938, for example stored in a multispectral data calibration parameters matrix, may enable correct color measurement irrespective of the position and the orientation of the multispectral measurement system 2200SS with respect to the sample being measured. The multispectral measurement system calibration method 1900 may enable a user to acquire one or more measurements, for example corrected measurements, of the sample from one or more orientations and positions, for example by continuously moving the non-contact multispectral measurement device 100 with respect to a sample or patch to be measured.

In greater detail, the device uses multispectral sensor to obtain multispectral data. Increased amount of data comprised in the multispectral data 2026 collected by the multispectral measurement system 2200SS may be greater than the amount of data that may be collected by, for example, an RGB or other color sensor, for example a trichromatic color sensor. The mobile or handheld device comprising a multispectral measurement system 2200SS may comprise one or more methods for processing multispectral data, for example computer-readable instructions stored on a non-volatile memory device for processing multispectral data. The multispectral data 2026 may be corrected using data from the positioning sensor 2200PS, for example one or more of orientation and position data relative to a sample or target being measured. The calibration method 1900 may be used to determine parameters, for example multispectral data calibration parameters, which allows the use of multispectral data for all use cases. These detected values are corrected using position correction step 2208, 2024, 2122. The parameters may comprise sensor information described earlier allowing for increased flexibility when positioning the device with respect to the target. Calibration determines parameters of the position correction algorithm, which are dependent on the sample or target type, for example, the type of material, dependent on one or more of sample texture, translucency, gloss, sparkle, color, and appearance. From a user viewpoint, the parameters may be dependent on a use case, for example to measure fabrics, skin, paint, paint comprising effect pigments, minerals, and polymers.

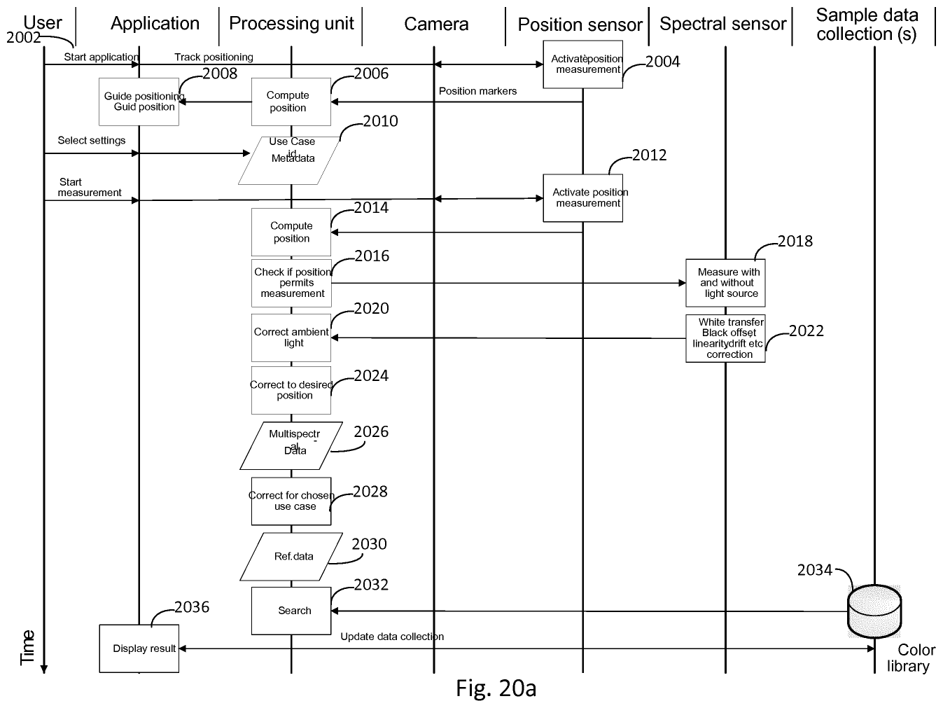

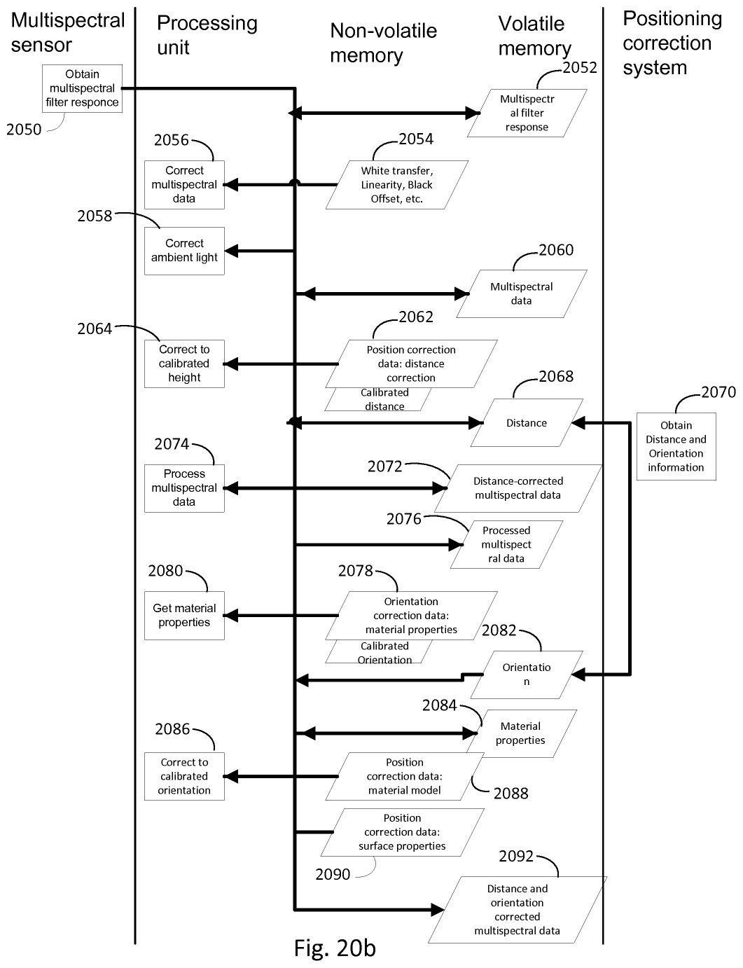

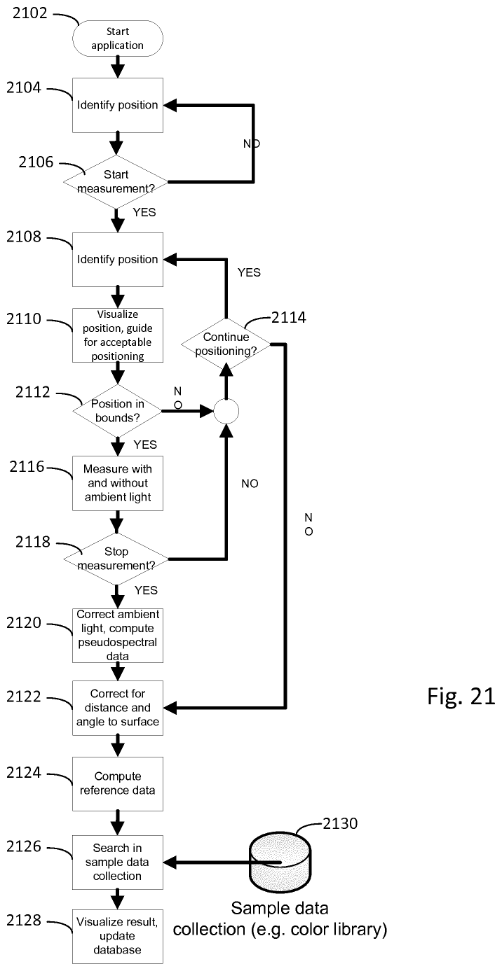

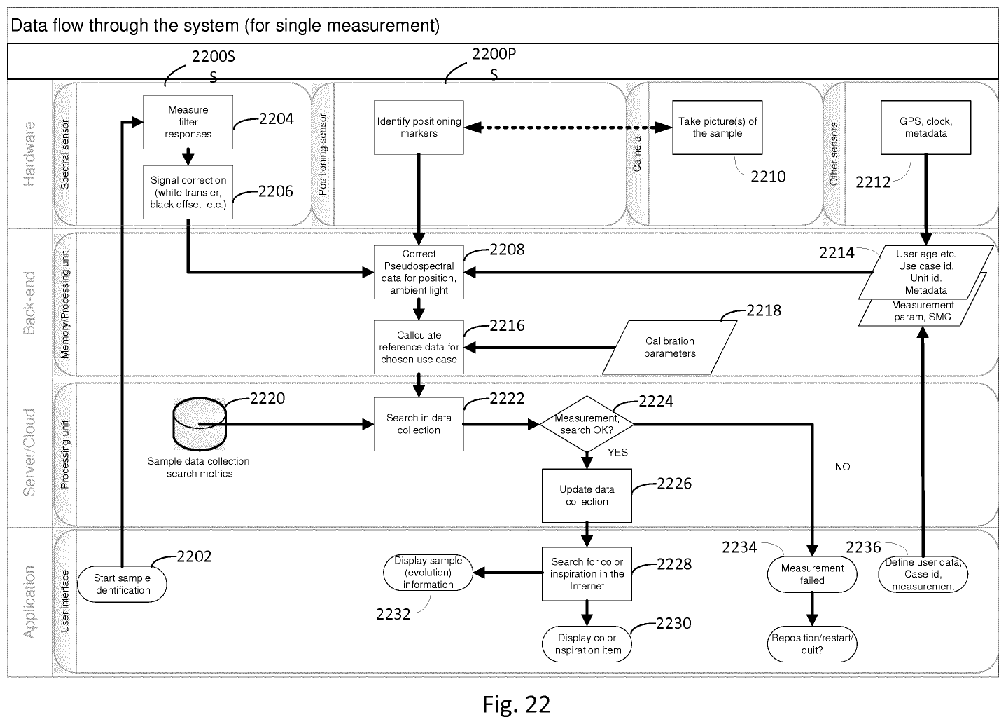

As mentioned earlier, position-corrected multispectral data is used as an input to the colorimetric calibration step. The colorimetric calibration step may be used for transforming the position-corrected multispectral data into colorimetric coordinates, for example one or more of XYZ, L*a*b*, CIE tristimulus coordinates, and further quantities that may be used to search a match, for example a color match, for the measured sample, patch, or target in the reference database 1910 in FIG. 19, 2034 in FIG. 20, 2130 in FIG. 21, (database 2220 in FIG. 22), for example in one or more of a Pantone Color Library, a commercial paint database, and a products database. This part of the calibration is dependent on each device properties and on the use-case, for example the type of material. The target-related values may be used to search in the reference database (1910 in FIG. 19, 2034 in FIG. 20, 2130 in FIGS. 21 and 2220 in FIG. 22), which may contain measurements made using the reference device and may be use case dependent.

The method for color calibration comprises improvements that may accelerate the calibration process. Calibration data needed to obtain multispectral data from raw filter values (steps 1924, 1926 FIG. 22) is determined for each calibrated device and is largely independent from the use case. Position correction parameters, on the other hand, are largely dependent on the use case nature. The calibration process (1918, FIG. 22) aiming at determining parameters of the position correction algorithm, (1918a, FIG. 22), is considered quasi-static when compared to variation of multispectral sensor properties (steps 1922, 1924, 1926 and 1928 FIG. 22) and is determined for a large batch of calibrated devices. Calibration data 1938 needed to obtain reference data (e.g., color coordinates) from multispectral data is determined employing a virtual model 1934 of the device based on its sensing and illumination properties (in particular, 1922) in order to speed-up the calibration. Device model 1936 and information about the use case (e.g. as a collection of reference targets and their measurements by a reference device 1910) are used as an input to the virtual model which delivers simulated multispectral data with potentially less time and resource investment than a measurement of the underlying reference targets. This simulation is used in an optimization 1936 that searches for proper parameters of the calibration algorithm.

In view of the foregoing, calibration may be divided into three parts; use case-related calibration 1902, multispectral device calibration 1904, and combining use case-related calibration parameters and device calibration parameters 1930. Determining calibration parameters in stages allows for greater flexibility and reduced duplication of calibration efforts. For example, use case related calibration 1902 may be combined with different types of multispectral devices, and device calibration 1904 may be used with different use case parameters on an as-needed basis.

Use case calibration describes a general workflow to obtain the reference data for a given particular color database (print, skin tone, architectural paint, textiles, etc.) and is performed for each use case or when reference measurement procedure is changed. Multispectral device calibration is done for each non-contact spectral measurement system. As was mentioned earlier, positioning correction parameters determination 1918 is done once for larger batches of devices to calibrated multispectral devices. It depends on the medium and is assigned in the use case calibration. Use case calibration may be done only occasionally and is not necessarily synchronized with the device calibration workflow.

Part of the use case related calibration may be performed with a reference device 1906. Different sample types often require different reference devices. For example, measurements of skin samples may require non-contact measurement with spherical spectrophotometers. Additionally, to allow for database creation to be distributed amongst different users and/or institutions, the reference device should have good inter-instrument agreement, tight population and good reproducibility. Measurements do not necessarily have to be made in a laboratory with a high-grade instrument. The measurement may be performed by users using a multispectral device as described herein or other mobile multispectral devices, especially if the datasets for a use case are small, e.g. if the data collection holds skin measurements of one user (step 2128 FIG. 21, step 2226 are an illustration of the data collection update). In view of the foregoing, the reference device preferably has the same or a similar geometry as the multispectral measurement system to be used on a non-contact multispectral measurement device 100, but it does not need to be the same if there are advantages to using a reference device that has a geometry that is better suited to a particular set of samples for a use case or if the use case requires more precise measurement than the multispectral measurement system can provide. Reference device 1906 measures samples 1908 that are representative of a given use case. Color data, metrics and metadata may be stored in a reference database 1910.

The characterization device 1912 should have optical geometry and characteristics similar to or the same as a multispectral measurement system as described herein. The characterization device is used to perform calibration steps which are representative of a type or class of multispectral measurement systems, and may be used to derive calibration parameters for that type of multispectral as applied to a given use case. Pre-characterizing parameters common to a class of multispectral measurement systems reduces calibration efforts during manufacturing and calibration of individual units (step 1904, FIG. 19). It is further employed to define reduced model to transfer measurements from the reference device to the characterization device in step 1914, as described in more detail below. The transfer is done to account for different optics, measuring geometry and/or measuring procedure of the reference device. This step may be done by combining the reference optics with the multispectral detector to define how optics of the reference device influences the transfer parameters 1914a. Recommended measurement parameters may be defined in step 1916, including integration time, gain, signal to noise ratio (SNR), etc. 1916a, and the parameter of averaging procedure. They are later stored to define measurement parameters and statistical measurement correction (SMC), c.f. 2214, FIG. 22. The positioning correction parameters may be defined in step 1918, including positioning correction data and positioning bounds 1918a.

With respect to the step of measuring correspondence to the reference device 1914, an operation is performed to provide a reduced model between the characterization device and reference device in order to bring their measurements close to each other. In its most simple form the transformation can be defined as follows. If reference device signal is a vector R^{ref} of dimension n^{ref} while the characterization device delivers filter responses F^{test}, a vector of dimension N^{test} the correspondence operator denoted by B can be thought of a series of vector-matrix operations.

Rᵢ^{ref}=[B(F^{test})]ᵢ=dᵢ^{cor}+Σⱼ₌₁^{N}^{^{test}}B_{i,j}^{cor,1}ƒⱼ^{cor}(Fⱼ^{test})+Σ_{j,k=1}^{N}^{^{test}}B_{i,j,k}^{cor,2}ƒⱼ^{cor}(Fⱼ^{test})ƒₖ^{cor}(Fₖ^{test})+ . . .

For each index i=1, . . . n^{ref}. With linear operators B^{cor,q} for polynomials of rising dimension, constant shift dᵢ^{cor} and the nonlinear functions ƒ^{cor} to account for, e.g. different linearity properties of the devices and is often a piecewise polynomial. It can also take the form of an activation function so that the model incorporates a neural network. Parameters are found by first measuring nonlinearity properties on e.g. neutral targets with Lambertian surface properties to obtain d^{cor} and ƒ^{cor} Afterwards, a series of samples relevant to the case and samples having clearly defined properties (e.g. BCRA tiles) are measured, total m^{cor}, and an optimization problem is started. One example could be a generally nonlinear optimization problem. These parameters later become part of multispectral data 1938 calibration parameters needed to form reference data from the position corrected multispectral data (step 2216, 2030, 2124).

$$[ \begin{matrix}{d}_{1}^{c o r} \\ ⋮ \\ {d}_{1}^{c o r} \\ {B}_{1 , 1}^{cor , 1} \\ ⋮ \\ {B}_{{N}^{test} , {N}^{t e s t}}^{c o r , 1} \\ {B}_{1 , 1 , 1}^{cor , 2} \\ ⋮ \\ {B}_{{N}^{test} , {N}^{t e s t} , {N}^{t e s t}}^{cor , 2} \\ ⋮\end{matrix} ] = argmin [ {\sum }_{i = 1}^{{m}^{c o r}} {w}_{i}^{c o r} {E}^{c o r} ( B ( {F}^{test , i} ) , {R}^{ref , i} ) ]$$

With weighting parameters wᵢ^{cor} and (generally nonlinear) distance function E^{cor}. The latter can be a vector norm or a nonlinear metric such as colorimetric delta E. Additional matrix-vector (in)equality constraints can be set to assure that for a white tile the difference in signals or XYZ coordinates do not drift far apart after the nonlinear transform.

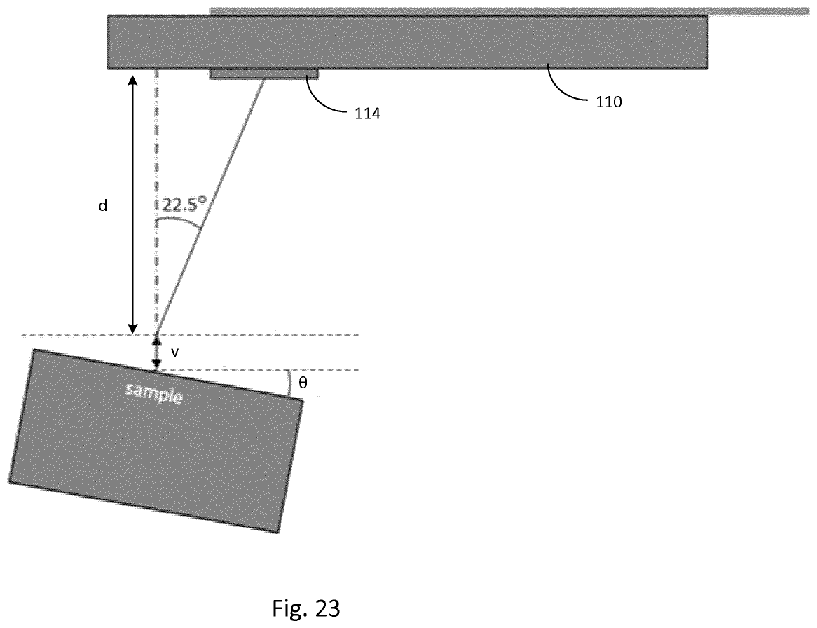

With respect to step 1918, calibration to obtain correction parameters to correct for variations in distance and orientation of the multispectral measurement system relative to the surface being measured is performed (step 2024, 2122, 2208). Referring to FIG. 23, measurements made by a multispectral measurement system 110 under test are recorded from measurements with a target sample at different distances which vary from a target distance d by an amount v, and at various angles θ to a sample surface. The sample measurements may include targets relevant for case as sell as colors with different media properties (e.g. sample sets with different gloss properties or color reference samples like BCRA tiles).

The series of measurements allows one to design a correction scheme for using the positioning system to guide the multispectral measurement system into the desired position(s) for the non-contact measurement and the bounds of positioning where the desired trade-off between the usability and precision may be attained (used in steps 2016, 2110, 2112). The boundaries take the precision of the positioning sensor into account this precision can be transferred into the errors of the pseudospectra to derive acceptable bounds. As mentioned previously, these measurements may be performed using the characterization device and can be assumed quasi-static, i.e. constant for large numbers of devices under calibration.

For example, correction of the distance h to the required position h₀ may take form of a polynomial

$${F}_{j}^{test} ( h ) = A ( {F}^{test} , h , {h}_{0} ) {F}_{j}^{test} ( {h}_{0} ) = [ {a}_{0}^{h e ight} ( {F}^{test} ) + {a}_{1}^{h e ight} ( {F}^{test} ) ( h - {h}_{0} ) + {a}_{2}^{h e ight} ( {F}^{test} ) {( h - {h}_{0} )}^{2} ] {F}_{j}^{test} ( {h}_{0} )$$

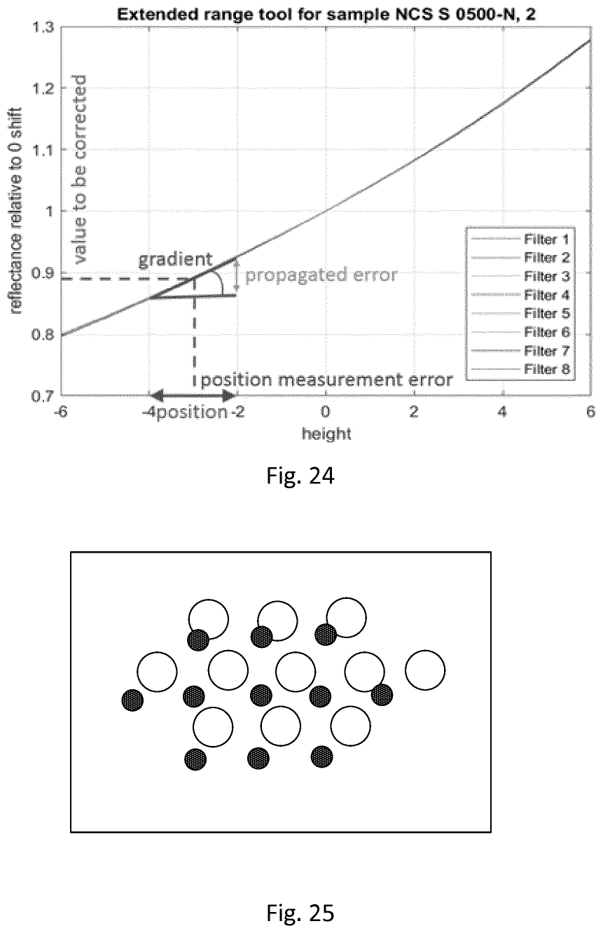

As shown in FIG. 24, in case position sensor has an imperfect precision, stability of the correction curve defines the propagated error from the positioning sensor. In FIG. 23, the device is positioned v=3 mm from target distance d. Position measurement effort is transformed into an uncertainty in the value of A(F^{test}, h, h₀). The desired uncertainty defines the bounds of the positioning. Parameters a₀^{height}, a₁^{height}, a₂^{height} may be scalar or themselves include functional dependences on multispectral data.

Additional correction for orientation may be applied together with the distance correction. Distance and orientation corrections may be applied together, in parallel, sequentially or iteratively. Angle of orientation correction may include bidirectional reflectance distribution function (BRDF) parameters, such as a model of the surface effects (e.g., amount of gloss, texture), sample characteristics and substrate nature. An example of applying a BRDF model is a correction based on the Oren-Nayar model with dynamically determined parameter. See, for example, Michael Oren and Shree K. Nayar, Generalization of Lambert's reflectance model, In Proceedings of the 21st annual conference on Computer graphics and interactive techniques (SIGGRAPH '94). ACM, New York, N.Y., USA, 239-246.

As such, a case dependent model of cavity angle standard deviation σ dependence on filter signals may be derived. For example, filter responses F̅₁, . . . , F̅_{N}_{^{test}} for a series of use case dependent patches with known material properties are measured during step 1918 at calibrated distance h₀ and varying orientation angles, (for example, varying in-plane orientation angle θ). Measured filter responses and known material properties (e.g. cavity angle standard deviation a) are used to derive parameters of the orientation correction step. For example, parameters d₁, d₂ are derived such that material properties (e.g. σ) during measurement process (FIG. 20) of an unknown sample may be put into correspondence with the distance corrected filter responses F̅₁, . . . , F̅_{N}_{^{test}}, e.g. σ≈d₁+d₂ Σᵢ₌₁^{N}^{^{test}} F̅ᵢ. Parameters, e.g. d₁, d₂ are part of the position correction algorithm parameters 1918a which is later stored in the memory of the multispectral sensing device. This procedure may include different forms of data processing instead of making sum of multispectral data, such as taking mean, maximum, etc.

Moreover, surface properties are measured during step 1918 using the plurality of calibration patches. For example, change of filter response F̅₁, . . . , F̅_{N}_{^{test}} at calibrated distance are measured on dark calibration patches to define the orientation-dependent surface component Dₛ (σ, θ) as difference between filter response at calibrated orientation and varying orientation value. The component may be defined as a dependence, using spline approximation of measured values as a function with arguments σ, θ.

The system optics may include diverging light beams. This property leads to signal changing with distance. The correction may be made as follows. Assume that the multispectral device delivers multispectral data F₁, . . . , F_{N} for some N, the calibrated distance and orientation are h₀, θ₀ and the distance and orientation measured by the position correcting system are h, θ. Correction algorithm has following inputs:
multispectral data F₁, . . . , F_{N} as
parameters d₁, d₂, a₀^{height}, a₁^{height}, a₂^{height} of the distance and orientation correction algorithm. Additionally, functional dependence Dₛ(σ, θ) of the surface component.
position information delivered by the position correcting system (e.g. distance and orientation angles h, θ) together with calibration position h₀, θ₀.
   Output of the algorithm are distance and orientation corrected multispectral values F̅₁, . . . , F̅_{N}.
   The algorithm may be implemented as follows.
1. the distance correction is made based on the distance shift h−h₀. The step has multispectral values F₁, . . . , F_{N} as an input as distance corrected multispectral values F̅₁, . . . , F̅_{N} as an output. For example, F̅ᵢ=Fᵢ/A(F^{test}, h, h₀) for i=1, N. Parameters of operator A(F^{test}, h, h₀) are found during step 1918 as described previously.
2. The corrected multispectral data is summed up. The step has distance corrected multispectral data F̅₁, . . . , F̅F_{N} as an input and sum of the distance corrected multispectral data Σᵢ₌₁^{N}F̅ᵢ as an output.
3. This sum Σᵢ₌₁^{NF̅}ᵢ is used as an argument of a linear relation with parameters defined by the calibration step 1918 to define material property, the standard deviation σ of the orientation of the cavities used in the Oren-Nayar model. Inputs of this step include parameters d₁, d₂ and the sum of distance corrected multispectral data Σᵢ₌₁^{N} F̅ᵢ. An output of the step is the material property of the surface, e.g. σ. As mentioned previously, this step may have the form σ≈d₁+d₂ Σᵢ₌₁^{N} F̅ᵢ with parameters d₁, d₂ being part of the parameters 1918a defined during step 1918 and stored in device memory.
4. The Oren-Nayar model is used to find the relation of the filter value at desired orientation to the filter value at current orientation, denote it D (σ,θ). Then, distance corrected filter values are multiplied by D (σ,θ) to arrive at the orientation and distance corrected filter values \tilde{F}₁, . . . , \tilde{F}_{N}. For targets with strong surface properties, an orientation-dependent surface component Dₛ(σ, θ) depending on the orientation angle θ and defined during step 1918 is subtracted from the distance-corrected multispectral data before it is multiplied by D(σ, θ). Inputs of this step include distance corrected multispectral data F̅₁, . . . , F̅_{N}. Outputs of this step include distance and orientation corrected multispectral data \tilde{F}₁, . . . , \tilde{F}_{N}. For example, F̅ᵢ=D (σ, θ) (Fᵢ−Dₛ (σ, θ)) for i=1, . . . N.
   This procedure may be iterated: distance correction is defined again followed by the orientation correction.

The material properties (e.g. cavity angle standard deviation σ) as well at material correction parameters may be set or corrected by the user in the settings 2036. Alternatively, material parameters may be defined automatically using device illumination and picture of the sample taken by the camera 2010. Knowing geometry of illumination relative to the camera pickup one can put reflectance or color information detected by the camera at a specific position of the sample in relation to the angle of the incoming illumination beam at this position. The BRDF may be derived from the correction model parameters as set forth above and/or the BRDF may be detected automatically using the camera 2010. Automatic BRDF detection requires no presetting of the position correction parameters in the nonvolatile device memory. Corrections may be made to multispectral data based on such BRDF information.

Another part of the calibration process in characterizing the device 1920, includes the steps to define multispectral calibration parameters relevant for each multispectral measurement system, but not for the use-case so it can be done once for each device (step 1922, 1924, 1926). This involves determining saturation, optimal gain and other parameter to optimally measure the samples of the use case. Data like signal-to-noise ratio (SNR) and the noise model is used to model the test and device and the device under calibration.

Calibration for each multispectral measurement system 110 may be divided into two parts. The first part aims at defining parameters which help transform raw data from the multispectral detector into multispectral information during the early stages of data processing (cf. step 2022, FIG. 20, step 2206, FIG. 22), These are calibration steps such as measuring neutral targets in step 1924 to determine white transfer and linearity information 1924a and the blacktrap measurement in step 1926 to determine black offset information 1926a. They are needed to compute multispectral information before position correction in step 2208, FIG. 22.

The second part of the calibration is performed for each multispectral measurement system 110 and for each use-case. It delivers parameters defining computation of colorimetric coordinates or other data computed in step 2216 FIG. 22 which needed to perform search in the reference database in step 2220, FIG. 22. For faster calibration, in step 1922 filter curves S^{filt,i}(λ) for all filters i=1, . . . , N^{calib} and the LED spectra L(λ) are measured at a sufficient number of points. The filter curves correspond to the filter functions for the photodiodes of the color detector, as illustrated in FIG. 8. Using a quadrature rule Q over the wavelength domain of the multispectral sensor, a mathematical approximation of the filter responses is created

Fᵢ^{calib,sim}=g(F^{calib})(Q(R^{ref}S^{filt,i}L)+ε

where the function g(F^{calib}) includes white normalization and linearization. Term ε includes additional parameters, such as noise defined for the characterization device. As shown in FIG. 19, additional measurements may be done in step 1928 to further trim the model by comparing simulated filter values with the real filter values for a limited number of filters. They may be used to adjust the model in step 1936 or serve as support vectors during optimization in step 1938. They may also be used to adjust the operator B in step 1914. For some devices, the number of measured targets should be increased if the use case is not yet studied. This part is not limited to measurements during the production. They may also be performed by the user to adjust the model or account for the instability and drift in the non-contact multispectral measurement device 100 hardware. The samples may be unrelated to the use case in question, e.g. they may be part of the Pantone color library. Physical targets may be produced by a third party company. Their measurement and subsequent calibration parameter correction is then a separate part of the device workflow (FIG. 20) with the option of doing the correction on the server.

Using the calibrated device model, device parameters such as SNR, samples measured with the calibrated device and the reference device database, optimized parameters are derived and stored in step 1938. The optimized parameters are used to derive filter or colorimetric data from values from the multispectral color detector. A formula similar to the one for the operator B may be used to adjust the signals before calibration. For values chosen as reference data, the calibration parameters determined during the calibration step. It is similar to the optimization problem for the operator B. For example, the optimization delivers a linear operator to transform the multispectral coordinates to XYZ colorimetric coordinates followed by transformation into L*a*b* coordinates followed another linear correction. In this case, the correction model may be as follows. Assume that the (position corrected) multispectral information is denoted by \tilde{F}^{calib} being a vector of length N^{calib} (in some instances, N^{calib}=N^{test} if characterization and calibration devices are similar). For illustration we assume that the operator B has a simple form of a matrix multiplication and shift acting only on the XYZ coordinates. The step 2216 in FIG. 22 takes the form:

$$( \begin{matrix}X \\ Y \\ Z\end{matrix} ) = {B}^{calib} {\tilde{F}}^{calib} + {d}^{calib} \\ ( \begin{matrix}{L}^{*} \\ {a}^{*} \\ {b}^{*}\end{matrix} ) = LAB ( \begin{matrix}X \\ Y \\ Z\end{matrix} )$$

Where LAB is function implementing standard L*a*b* calculation from XYZ, B^{calib XYZ} is a matrix with 3 rows and N^{calib} columns, vectors d^{calib XYZ} has 3 rows. These elements are part of the multispectral data calibration parameters 1938 and may be defined in step 1936 by obtaining simulated raw data F^{calib, sim}, transforming it to multispectral data and running an optimization. Various merit functions are possible, including hit-rate. One simple illustration would be quadratic difference to the reference device. Assume that, as previously, there are i=1 . . . m^{cor} reference targets and that the corresponding reference L*a*b* coordinates are \hat{L}*⁽ⁱ⁾â*⁽ⁱ⁾\hat{b}*⁽ⁱ⁾. Optimization problem may be stated as follows

$$[ \begin{matrix}{d}_{1}^{calib} \\ ⋮ \\ {d}_{3}^{calib} \\ {B}_{1 , 1}^{c ali} \\ ⋮ \\ {B}_{3 , , {N}^{calib}}^{calib}\end{matrix} ] = argmin [ {\sum }_{i = 1}^{{m}^{cor}} {w}_{i}^{calib} {E}^{calib} ( LAB ( {B}^{calib} {\tilde{F}}^{calib} + {d}^{calib} ) , ( \begin{matrix}{\hat{L}}^{* ( i )} \\ {\hat{a}}^{* ( i )} \\ {\hat{b}}^{* ( i )}\end{matrix} ) ) ] \qquad eq . 1$$

or, for example, for a multispectral detector comprising eight filters

$$( \begin{matrix}X \\ Y \\ Z\end{matrix} ) = ( \begin{matrix}{B}_{1 , 1} & … & {B}_{1 , 8} \\ … & … & … \\ {B}_{3 , 1} & … & {B}_{3 , 8}\end{matrix} ) {\tilde{F}}^{calib}$$

with parameters B_{1,1} . . . B_{3,8} defined as a solution of the problem eq. 1 with weighting parameters wᵢ^{calib} and (generally nonlinear) distance function E^{calib}. The optimization step may be done on a non-contact multispectral measurement device 100 or on a cloud server.

As noted before, the calibration and correction algorithms are designed to work with the spectral measurement data. This concept provides higher accuracy and increases the flexibility to use the data sets in an open system architecture supporting different applications with different calibration requirements. Calibration profits from the multispectral nature of the data. It is also possible that the number of channels and their positioning would allow for direct computation of the colorimetric coordinates in case of a hyperspectral or full spectral measurement system (e.g., when the channels deliver an approximation to the signal over the full wavelength range with 10 nm or smaller step size). In a hyperspectral or full spectral measurement system the calibration matrix can also be avoided.

Device characterization (1914, 1922, 1924, 1926, 1928) is used to simulate the multispectral measurement system. This step allows for the calculation of the multispectral data the multispectral measurement system 110 would deliver for the sample collection held in the sample data collection. This largely virtual simulation of filter responses to a large number of measurements taken by the reference device may be performed on a computer to define parameters needed to obtain filter and colorimetric data described in step 2216 in FIG. 22.

Device calibration may also involve measuring samples from a sample library 1928. This allows to each calibrated device to include correction to the calibration data. This step is presented as a separate block in FIG. 19. This step may partly be delegated to the end-user, if the sample data with controlled standard properties is distributed to the user or purchased by the user.

FIGS. 20a, 20b, 21, and 22 illustrate steps involved in making a measurement with a non-contact multispectral measurement device 100 according to the present invention from three perspectives, time, sequence and dataflow, respectively. FIGS. 20a and 20b show examples of how a work flow progresses over time. Referring to FIG. 20a, the initial step is to start the software application 2002. Position measurement is activated 2004, device position (i.e., distance and orientation with respect to the surface of interest) is computed 2006, and guidance is provided to the user 2008 to position the non-contact multispectral measurement device 100 at an appropriate distance and orientation to the surface to be measured. The appropriate use case calibration data is retrieved in 2010. Position continues to be measured and computed, 2014, and if position permits measurement 2016, one or more measurements are made 2018. Several measurements may be averaged or statistically combined using the statistic measurement correction procedure (SMC) which may include, but is not limited to, averaging procedure defined in step 1920 of the calibration.

Measurements may be made with and without activating LED illumination sources 2018 to allow for correction for ambient light 2020 with input parameters such as white transfer and black offset 2022. Parameters for step 2022 are found during the device specific calibration steps 1922, 1924, 1926 of the device specific calibration process 1904 as described earlier. Additionally, ambient light may be measured by an ambient light sensor. Time modulated light and demultiplexing may also be used for ambient light correction (lock-in techniques). Corrections to multispectral data from the multispectral detector may be made to compensate for device distance and orientation (parameters 1918a are found during step 1918 of the optimization) to the sampled surface 2024 and for ambient light 2020 to produce corrected multispectral data 2026. The multispectral data may then be corrected for the selected use case 2028. Parameters of the correction 1938 are found during device and use case specific calibration as described earlier. Reference data is accessed in 2030. The corrected spectral data may then be used to search 2032 a color database 2034, results may be displayed 2036.

Referring to FIG. 20b another example of a workflow is provided. The multispectral measurement system 110 is activated in step 2050 to obtain multispectral filter responses 2052. The multispectral filter responses are corrected for white transfer, linearity, back offset parameters 2054 in step 2056. Correction for ambient light is performed in step 2058 to provide multispectral data 2060. Position measurement is activated and device position (i.e., distance 2068 and angle of orientation 2082 with respect to the surface of interest) is obtained 2070. Corrections to multispectral data from the multispectral detector may be made to compensate for device distance 2068 to the sampled surface 2074 to produce distance corrected multispectral data 2072. Processed multispectral data 2076 is stored in memory.

Orientation data 2082 and orientation calibration information 2078 are accessed. In step 2080 material properties 2084 of the surface being samples are accessed depending on use case. The multispectral data may then be corrected 2086 for orientation of the multispectral system toward the surface being sampled 2082, a model of the surface being sampled 2088, and other surface properties 2090, to produce distance and orientation corrected multispectral data 2092.

FIG. 21 illustrates a logical sequence for obtaining color measurements with a device according to the present invention, including several loops that may be interrupted by an event triggered by user action or by a timeout. The workflow in this section starts when user opens the application 2102. After the application is started, the positioning system, optionally together with the camera, starts observing the scene to bind position markers 2104. In step 2106, a decision is made whether to proceed with a measurement. Device position may be continued to be monitored in either case, at 2104, 2108. In 2110, the display may display audio-visual information to guide user closer to the desired position. The camera positioning markers of the positioning system may be visible so that the approximate position of the measurement is visible. The camera can further capture the whole scene which the sample is a part of so that the user gets the additional information of the sample together with its position in the scene. The application waits for user input to start a measurement or a series of measurements.

After measurement(s) are started by the user, the positioning markers, already calculated and identified by the position correction system, are used to identify device distance and angle relative to the surface being sampled. The application provides a visual indication of whether position is in bounds 2112 so that the measurement can be performed within bounds that are capable of being corrected. The bounds are decided during the step 1918 of the calibration. Depending on the tradeoff between position and measurement precision defined during the calibration or additionally changed by the user, the application decides whether the position is close enough 2112 so that the sensor correction may be applied while guidance is shown to user on the screen. If the decision is negative, decision is taken by the user or by timeout whether a measurement should be made or whether further positioning will be attempted.

If the position is appropriate, a measurement is performed 2116 as described below with and without additional illumination to compensate for the ambient light. The measurement may be stopped in 2118 or additional measurements may be made. The measurement is stored in device memory and a loop termination condition is applied. If the loop continues, the series of measurements is made as was described earlier.

If the measurements are finished, the data collected during the loop is processed by applying steps including correcting ambient light and computing multispectral data 2120, correcting for distance and angle to the surface 2122, and computing reference data 2124. Aggregated and processed information from positioning sensor, camera and multispectral sensor is passed for search 2126, the result is visualized 2128, additionally the sample data collection 2130 is updated. After the workflow is finished, the application is put into stand-by mode for the user to start another series of measurements or otherwise interact with the application by e.g. changing the measurement parameters.

When the application is started, but before the sample acquisition command is issued, the system is active with the positioning sensor observing the scene. It identifies the positioning markers. Several measurements are used to perform averaging and position correction aiming at colorimetric information.

The system has separate settings that may be accessed by the user through the application. Before starting the measurement or before performing the measurement in the sample data collection, usually including but not limited to, color library with corresponding metrics, the user can change the use case identity and supply metadata related to a particular measurement such as user age, geographic position, time of measurement, etc. In some applications e.g. when the measured sample is human skin, this metadata influences calibration data and can be used for search metrics, thus the sample data collection is not necessary reduced to color. Advanced settings include measurement parameters such as averaging procedure, gain and integration time. These are preset for each use case during calibration with the characterization device, but may also be changed by the user on demand. The user may also set the targeting bounds relative to the tradeoff between usability and positioning precision.

The dataflow of a single measurement is shown in the FIG. 22, from starting the measurement to displaying the results. For illustration purposes, it is shown here that the measurement is triggered by the user, such as manually or by voice. As depicted in FIG. 21, this is not the only option, measurements may also be performed in an automatic mode while the user changes and adjusts the position until the process is interrupted. In any case, a single measurement in this scheme may include a number of illumination and measurement pairs to compensate for the ambient light. For some applications, e.g. when a multispectral measurement system is embedded into a device having limited or no human user interfaces, the triggering of the measurement would be by the device and associated programming, not a manual input. In this case, the display and user interface serves to input the settings.

After the sample identification command is issued by the user 2202, the hardware is activated. Filter responses are measured 2204 by the multispectral detector. The signal measured by the multispectral detector passes the initial processing step where dark current, linearity etc. are corrected 2206. White correction and filter crosstalk correction are applied leading to multispectral information 2208. These parameters are found during steps 1922, 1924 and 1926 of the calibration as described earlier.

At the same time, device camera acquires images of the sample to define the distance and orientation of the device relative to the sample 2210. The positioning system may be designed to function with the device camera, have its own camera or be used without the device camera to define the position (e.g. use time of flight or employing stereovision).

When other sensors 2212 (e.g. clock, GPS) are present, then data may be appended by the user settings (age etc.) to form the sample metadata 2214 that may be used in the correction process 2208 (e.g. when correcting pseudospectra from the skin) or during the search in the sample data collection (e.g. searching for the last skin data related to the user).

The multispectral data is corrected for the ambient light 2208. The multispectral data are further corrected using the positioning information and an algorithm for position correction determined for each use case during the calibration (step 1918 of the calibration process described earlier). Positioning information includes, but is not limited to, distance and orientation (e.g., sample curvature can be supplied by the positioning system). As described above, a single measurement may be a part of a series of measurements. These measurements may be used to further interpolate the values to the desired position and perform averaging to minimize positioning sensor error and other random effects as described in the next paragraph. These parameters are part of the SMC parameters found in the step 1920 of the calibration.

Corrected filter responses and position information are supplied to the next processing step (also in 2208) where the filter responses are averaged in case multiple measurements were performed. They are further corrected using the calibration parameters 2218 supplied by the calibration of the multispectral measurement system 2216. Calibration includes, but not limited to, calibration to account for geometry or other differences between the reference device and the multispectral measurement system. During device specific and use case specific calibration, these parameters are found and stored in 1938. The calibration data also corrects the individual device features, so that unified data may be used with the sample database. Furthermore, the calibration is used to process the reference data (e.g. colorimetric data) from the multispectral data. For example, the XYZ or the L*a*b* is computed. The data is specific to the use case identity and can possibly be altered using the metadata. In FIG. 22, the calibration parameters are stored in the processing unit. They may additionally be accessed from a cloud-based server or on the server by supplying the unit identity.

The spectral data may be transferred to the cloud server for further processing. The reference database 2220 may be stored on the server, although this step may also or alternatively happen in the processing unit. The database may comprise sample color data for different illuminations measured by a third-party supplier as well as data related to the user (such as skin data for the user taken over time) and thus created by the user or by a group of users.

Part of the calibration data for the colorimetric system may be stored on the server/cloud and accessed using the unit ID for post processing. The database may also include products related to the sample measured and identifiable by the color and appearance information (such as foundation products for skin or paint).

The sample data collection also contains metrics and a set of rules to find the closest match to a measured sample, thus it may include some functionality of an expert system. These procedures are used to search in the color library to find the closest match 2222. For example, the match may be decided using the metadata such as looking for the last measurement of user skin. Alternatively, the closest match may be sought for by using colorimetric data, e.g. by calculating a metric comprised of a weighted sum of delta E to the measured sample under different illuminants.

If the search and measurement were successful 2224, the database may be updated 2226, e.g. the database of skin measurements of the user is augmented or the color information of a new inspiration is added together with the data supported by the user. The workflow is then passed back to the device 2228, more specifically, to the application which may display the color of the inspiration item 2230 or sample information 2232. If the measurement and/or search in the database have failed, the workflow is also passed back to the application 2234.

The camera of the device is used for targeting and positioning of the sample with respect to the device. The acquired images of the camera may be visualized on the device display. The individual images may be overlaid by positioning marks to guide the user to an optimal position. This provides direct user interaction for the operator and helps to support and control the measurement workflow.

The positioning marks may be placed on the images due to information of the positioning sensor. If a dot pattern projector is used the dots themselves may be used to guide the user as shown in FIG. 25 where circles indicate the range where the dots shall be. Another option is to use the position information to place marks on the image.

The SW application has stored information available to calculate the location of the detector pick-up area on the sample for different distance and angular orientations. This can be done by trigonometric calculations. This helps the SW application to provide on the display a position marker for the virtual position of the measurement field of the color sensor. The user may use this virtual marker to position it at the desired location in the sample image.

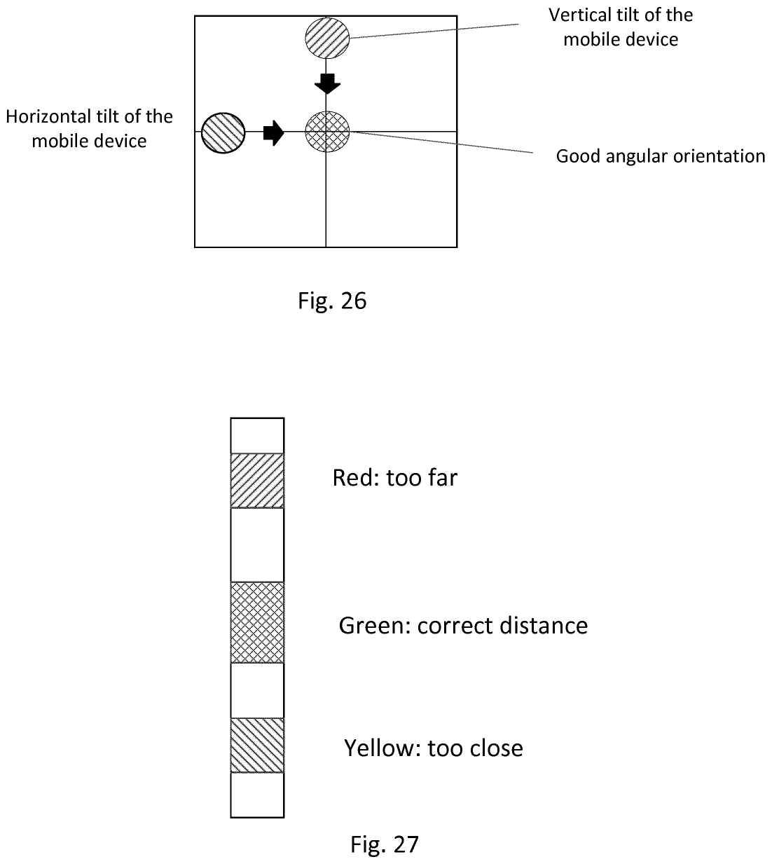

There are different possibilities to support graphically the user on the display with the distance and angular control. One possibility is to use a rectangular control window where the position of the marker corresponds to the measured angle. The goal is to shift the marker in the center of the window by tilting the non-contact multispectral measurement device 100 with the spectral sensor. The marker is red when the alignment is out of the angular tolerances. The marker becomes green as soon as the angular alignment is within the pre-determined tolerance limits. This is shown in FIG. 26. A similar concept can be applied for the distance control. This is shown in FIG. 27. Such alignment features may be superimposed to the real camera image of the scene.

A first method to initiate a measurement cycle and create a valid result is to align the distance and the angular orientation of the non-contact multispectral measurement device 100 until the display indicates that the position is within the tolerance bands around the reference position. Then, start a single measurement by a control interaction. The control interaction may comprise pressing a button or voice command.

A second method is to execute a series of multiple measurements around the reference position. All measurements are stored. For each measurement the distance is corrected. The angular information for each measurement is used for an interpolation of the measurement results at the reference angle.

Exemplary embodiments of the present invention include, but are not limited to, the following.

A non-contact multispectral measurement device for measuring reflectance properties of a surface of interest, comprising: a multispectral measurement system configured with a measurement geometry having an illumination light path and an observation light path for obtaining multispectral values of the surface of interest; a position measurement system for measuring position values of the multispectral measurement system relative to the surface of interest; and means to correct multispectral values from the multispectral measurement system based on detected position values from the position measurement system.

The non-contact multispectral measurement device as above, wherein the detected position values include at least a distance and an orientation angle of the multispectral measurement system relative to the surface of interest.

The non-contact multispectral measurement device as above, wherein the position measurement system includes a camera to assist in targeting of a measurement area on the surface of interest.

The non-contact multispectral measurement device as above, wherein the position measurement system includes a camera and a display to assist in targeting of a measurement area on the surface of interest.

The non-contact multispectral measurement device as above, wherein the observation light path is inclined from the surface normal by at least 15 degrees.

The non-contact multispectral measurement device as above, wherein the observation light path angle is inclined from the surface normal by at least 20 degrees.

The non-contact multispectral measurement device as above, wherein the observation light path is inclined from the surface normal by approximately 22.5 degrees.

The non-contact multispectral measurement device as above further comprising a retro-reflection measurement geometry, wherein the observation light path and the surface normal define a plane of incidence, and the illumination light path, when projected onto the plane of incidence, is inclined with respect to the surface normal at an angle that differs from the observation light path's angle by less than 10 degrees.

The non-contact multispectral measurement device as above further comprising a retro-reflection measurement geometry, wherein the observation light path and the surface normal define a plane of incidence, and the illumination light path, when projected onto the plane of incidence, is inclined with respect to the surface normal at an angle that differs from the observation light path's angle by less than 5 degrees.

The non-contact multispectral measurement device as above further comprising a retro-reflection measurement geometry, wherein the multispectral measurement system comprises at least one illumination source, a multispectral detector, and optics coupled to the illumination source and to the multispectral detector to provide the retro-reflection measurement geometry, wherein the observation light path and the surface normal define a plane of incidence, and the at least one illumination source is located offset from the multispectral detector and on a line that is substantially perpendicular to the plane of incidence.

The non-contact multispectral measurement device as above, wherein the observation light path and the illumination path are inclined from the surface normal by between 20 and 30 degrees.

The non-contact multispectral measurement device as above, wherein the observation light path and the illumination light path are inclined from the surface normal by between 20 and 25 degrees.

The non-contact multispectral measurement device as above, wherein the observation light path and a projection of the illumination light path onto the plane of incidence are both inclined from the surface normal by approximately 22.5 degrees.

The non-contact multispectral measurement device as above, wherein the at least one illumination source is a non-collimated illumination source.

The non-contact multispectral measurement device as above, wherein the at least one illumination source comprises at least a first illumination source and a second illumination source, the first and second illumination sources being located on opposite sides of the multispectral detector and on a line that passes through the multispectral detector and that is substantially perpendicular to the plane of incidence.

The non-contact multispectral measurement device as above, wherein the optics provide a divergent optical ray observation light path and a divergent optical ray illumination light path.

The non-contact multispectral measurement device as above, wherein the optics comprise at least one lens and a folded light path.

The non-contact multispectral measurement device as above, wherein the multispectral values comprises at least six channels of spectral information.

The non-contact multispectral measurement device as above, wherein the multispectral measurement system comprises a multispectral detector capable of measuring at least six channels of spectral information, and wherein the multispectral values comprises at least six channels of spectral information.

The non-contact multispectral measurement device as above, wherein the multispectral measurement system comprises at least one illumination source and a multispectral detector, wherein the at least one illumination source emits radiation over a range of visible light and wherein the multispectral data comprises visible light spectral information.

The non-contact multispectral measurement device as above, wherein the multispectral measurement system comprises at least one illumination source and a multispectral detector, wherein the at least one illumination source emits visible light radiation and infra-red radiation, and wherein the multispectral data comprises visible light spectral information and near infra-red spectral information.

The non-contact multispectral measurement device as above, wherein the multispectral measurement system comprises at least one illumination source and a multispectral detector, wherein the at least one illumination source emits visible light radiation and ultraviolet radiation, and wherein the multispectral data comprises visible light spectral information and ultra violet spectral information.

The non-contact multispectral measurement device as above, wherein the measurement device comprises a mobile communications device.

The non-contact multispectral measurement device as above, wherein the measurement device comprises a dedicated color measurement device.

The non-contact multispectral measurement device as above, wherein the position measurement system is selected from the group consisting of: a pattern projector and a camera, a camera autofocus system, a stereo vision system, a laser range finder, and a time of flight distance sensor.

The non-contact multispectral measurement device as above, wherein the means to correct values output from the multispectral measurement system based on values provided by the position measurement system comprises: a processor configured with instructions stored in an on-volatile memory that, when executed, cause the non-contact multispectral measurement device to: operate the position measurement system to obtain a distance and an angular orientation of the multispectral measurement system with respect to the surface of interest; operate the multispectral measurement system to acquire multispectral data corresponding to the surface of interest; and correct the acquired multispectral data for the distance and orientation of the multispectral measurement system with respect to the surface of interest to produce position-corrected multispectral data.

The non-contact multispectral measurement device as above, wherein the reflectance properties of the surface of interest include visible color information.

A non-contact multispectral measurement device for measuring reflectance properties of a surface of interest, the surface of interest corresponding to a use case of surfaces having similar reflective properties, the device comprising: a multispectral measurement system configured with a retro-reflection measurement path geometry having an illumination light path and an observation light path sufficiently inclined from a surface normal of the surface of interest to reduce gloss or surface reflection effects from the surface of interest, a position measurement system; a non-volatile data store, storing at least one set of use case calibration parameters and distance and orientation correction parameters; and a processor, in communication with the multispectral measurement system, the position measurement system, and the data store, the processor being configured with instructions that, when executed, cause the multispectral measurement device to: operate the position measurement system to obtain a distance and an angular orientation of the multispectral sensor with respect to the surface of interest; operate the multispectral measurement system to acquire multispectral data corresponding to the surface of interest; retrieve distance and orientation correction parameters from the data store and correct the acquired multispectral data for the distance and orientation to produce position-corrected multispectral data; retrieve use case calibration parameters from the data store and correct the position-corrected multispectral data to produce corrected multispectral data.

The non-contact multispectral measurement device as above, wherein the position measurement system further comprises a camera and a display in communication with the processor, wherein the processor is further configured with instructions that, when executed, cause the processor to display positioning guidance to a user based on the obtained distance and an angular orientation of the multispectral sensor with respect to the surface of interest and the field of view of the camera.

The non-contact multispectral measurement device as above, wherein the positioning guidance comprises displaying a virtual measurement point on an image of the surface of interest acquired by the camera.

The non-contact multispectral measurement device as above, further comprising the process of determining that the obtained distance and angular orientation multispectral measurement system are within a correctable range of distance and angular orientation before operating the multispectral measurement system.

The non-contact multispectral measurement device as above, wherein the position measurement system comprises a pattern projector and a camera, and the data store further stores calibration parameters for the pattern projector and camera.

The non-contact multispectral measurement device as above, wherein the pattern projector projects a plurality of position markers, and wherein the processor is further configured with instructions that, when executed, cause the camera to acquire an image including the position markers as projected on the surface of interest, and the processor processes the image to determine a distance and angle of a plane defined by the position markers relative to the camera and pattern projector.

The non-contact multispectral measurement device as above, wherein the pattern projector projects a plurality of position markers, and wherein the processor is further configured with instructions that, when executed, cause the camera to acquire an image including the position markers as projected on the surface of interest, and the processor processes the image to determine a three-dimensional shape of the measurement area.

The non-contact multispectral measurement device as above, wherein the processor is further configured with instructions that, when executed operate the multispectral measurement system to acquire a plurality of multispectral measurements of the surface of interest.

The non-contact multispectral measurement device as above, wherein a plurality of multispectral measurements of the surface of interest comprises at least one measurement with illumination from an illumination source and at least one measurement under ambient lighting conditions.

The non-contact multispectral measurement device as above, wherein the processor is further configured with instructions that, when executed, use the at least one measurement under ambient lighting conditions to correct the least one measurement made with illumination from an illumination source.

The non-contact multispectral measurement device as above, wherein the processor is further configured with instructions that, when executed, cause the processor to obtain ambient lighting conditions from the camera and correct the acquired multispectral data for ambient lighting conditions.

The non-contact multispectral measurement device as above, wherein the processor is further configured with instructions that, when executed, cause the processor to correct the acquired multispectral data for ambient lighting conditions prior to correcting for distance and orientation to the surface of interest.

The non-contact multispectral measurement device as above, wherein producing position-corrected multispectral data further comprises configuring the processor to: retrieve distance correction parameters from the data store and correct the acquired multispectral data for the measured distance to the surface of interest to produce distance corrected multispectral data; and retrieve orientation correction parameters from the data store and correct the distance corrected multispectral for orientation to produce position-corrected multispectral data.

The non-contact multispectral measurement device as above, wherein the use case correction parameters comprise a plurality of use case correction parameters, each set of use case correction parameters corresponding to a different type of surface to be measured.

The non-contact multispectral measurement device as above, wherein the different types of surfaces comprise at least two of textile surfaces, architectural paint surfaces, automotive coating surfaces, human skin and plastic surfaces.

The non-contact multispectral measurement device as above, wherein the illumination light path is inclined with respect to the surface normal within about 5 degrees of the observation light path.

The non-contact multispectral measurement device as above, wherein the illumination light path and the observation light path are inclined with respect to the surface normal by at least 15 degrees.

The non-contact multispectral measurement device as above, wherein the distance and orientation correction parameters include pre-determined distance correction coefficients, and distance correction is executed on the acquired multispectral by a correction polynomial using the pre-determined coefficients.

The non-contact multispectral measurement device as above, wherein the distance and orientation correction parameters include bidirectional reflectance distribution function (BRDF) parameters approximating the reflection characteristics of the measurement surface.

The non-contact multispectral measurement device as above, wherein the distance and orientation correction parameters include a predetermined bidirectional reflectance distribution function (BRDF) model and BRDF parameters and the correction of the acquired multispectral data for distance and orientation to produce position-corrected multispectral data includes fitting the parameters of a predetermined BRDF model approximating the reflection characteristics of the measurement surface.

The non-contact multispectral measurement device as above, wherein the BRDF model comprises an Oren-Nayar model.

The non-contact multispectral measurement device as above further comprising a camera, wherein the processor is further configuring to:
operate the camera to obtain an image of the surface of interest; and
derive a bidirectional reflectance distribution function (BRDF) model and BRDF parameters from the image of the surface of interest;
   wherein the correction of the acquired multispectral data for distance and orientation to produce position-corrected multispectral data includes fitting the parameters of a derived BRDF model approximating the reflection characteristics of the measurement surface.

The non-contact multispectral measurement device as above, wherein the image of the surface of interest is acquired by the camera with an off-axis illumination.

A method of generating correction parameters for measuring multispectral properties of a type of surface to be measured, comprising: measuring multispectral properties of a plurality of sample surfaces representative of the type of surface to be measured with a reference device to generate use case baseline parameters; measuring multispectral properties of the same or similar sample surfaces with a characterization device representative of a specific combination of optical measurement geometry, multi-spectral detector and illumination source; comparing the measurements with the use case baseline parameters to generate use case transfer parameters; generating unit-specific transfer parameters for an individual unit in production having a combination of optical measurement geometry, multi-spectral detector and illumination source that is substantially the same as the characterization device; combining the unit-specific transfer parameters with the use case transfer parameters to generate use case and device specific color calibration and correction parameters; and providing the use case and device specific color correction parameters to a non-contact multispectral measurement device.

The method as above, wherein the multispectral properties are obtained at varying angles and distances with respect to the plurality of sample surfaces.

The method as above, wherein the reference device and the characterization device do not have the same combination of optical measurement geometry, multi-spectral detector and illumination source.

The method as above wherein the step of generating unit-specific transfer parameters for an individual unit in production further comprises measuring reflectance properties of neutral targets with the individual unit in production.

The method as above wherein the step of generating unit-specific transfer parameters for an individual unit in production further comprises identifying multispectral detector filter curves and illumination spectra of the individual unit in production.

The method as above wherein the step of generating unit-specific transfer parameters for an individual unit in production further comprises measuring multispectral properties of the same or similar sample surfaces with the individual unit in production.

The method as above wherein the type of surface to be measured is selected from a group consisting of textiles, architectural paints, automotive coatings, human skin and plastics.

1. A non-contact multispectral measurement device for measuring reflectance properties of a surface of interest, comprising:
a multispectral measurement system configured with a measurement geometry having an illumination light path and an observation light path for obtaining multispectral values of the surface of interest;
a position measurement system for measuring position values of the multispectral measurement system relative to the surface of interest; and
means to correct multispectral values from the multispectral measurement system based on detected position values from the position measurement system.

2. The non-contact multispectral measurement device of claim 1, wherein the detected position values include at least a distance and an orientation angle of the multispectral measurement system relative to the surface of interest.

3. The non-contact multispectral measurement device of claim 1, wherein the position measurement system includes a camera to assist in targeting of a measurement area on the surface of interest.

4. The non-contact multispectral measurement device of claim 1, wherein the position measurement system includes a camera and a display to assist in targeting of a measurement area on the surface of interest.

5. The non-contact multispectral measurement device of claim 1, wherein the observation light path is inclined from the surface normal by at least 15 degrees.

6. The non-contact multispectral measurement device of claim 1, wherein the observation light path angle is inclined from the surface normal by at least 20 degrees.

7. The non-contact multispectral measurement device of claim 1, wherein the observation light path is inclined from the surface normal by approximately 22.5 degrees.

8. The non-contact multispectral measurement device of claim 1 further comprising a retro-reflection measurement geometry, wherein the observation light path and the surface normal define a plane of incidence, and the illumination light path, when projected onto the plane of incidence, is inclined with respect to the surface normal at an angle that differs from the observation light path's angle by less than 10 degrees.

9. The non-contact multispectral measurement device of claim 1 further comprising a retro-reflection measurement geometry, wherein the observation light path and the surface normal define a plane of incidence, and the illumination light path, when projected onto the plane of incidence, is inclined with respect to the surface normal at an angle that differs from the observation light path's angle by less than 5 degrees.

10. The non-contact multispectral measurement device of claim 1 further comprising a retro-reflection measurement geometry, wherein the multispectral measurement system comprises at least one illumination source, a multispectral detector, and optics coupled to the illumination source and to the multispectral detector to provide the retro-reflection measurement geometry, wherein the observation light path and the surface normal define a plane of incidence, and the at least one illumination source is located offset from the multispectral detector and on a line that is substantially perpendicular to the plane of incidence.

11. The non-contact multispectral measurement device of claim 9, wherein the observation light path and the illumination path are inclined from the surface normal by between 20 and 30 degrees.

12. The non-contact multispectral measurement device of claim 9, wherein the observation light path and the illumination light path are inclined from the surface normal by between 20 and 25 degrees.

13. The non-contact multispectral measurement device of claim 9, wherein the observation light path and a projection of the illumination light path onto the plane of incidence are both inclined from the surface normal by approximately 22.5 degrees.

14. The non-contact multispectral measurement device of claim 9, wherein the at least one illumination source is a non-collimated illumination source.

15. The non-contact multispectral measurement device of claim 9, wherein the at least one illumination source comprises at least a first illumination source and a second illumination source, the first and second illumination sources being located on opposite sides of the multispectral detector and on a line that passes through the multispectral detector and that is substantially perpendicular to the plane of incidence.

16. The non-contact multispectral measurement device of claim 9, wherein the optics provide a divergent optical ray observation light path and a divergent optical ray illumination light path.

17. The non-contact multispectral measurement device of claim 9, wherein the optics comprise at least one lens and a folded light path.

18. The non-contact multispectral measurement device of claim 1, wherein the multispectral values comprises at least six channels of spectral information.

19. The non-contact multispectral measurement device of claim 1, wherein the multispectral measurement system comprises a multispectral detector capable of measuring at least six channels of spectral information, and wherein the multispectral values comprises at least six channels of spectral information.

20. The non-contact multispectral measurement device of claim 1, wherein the multispectral measurement system comprises at least one illumination source and a multispectral detector, wherein the at least one illumination source emits radiation over a range of visible light and wherein the multispectral data comprises visible light spectral information.

21. The non-contact multispectral measurement device of claim 1, wherein the multispectral measurement system comprises at least one illumination source and a multispectral detector, wherein the at least one illumination source emits visible light radiation and infra-red radiation, and wherein the multispectral data comprises visible light spectral information and near infra-red spectral information.

22. The non-contact multispectral measurement device of claim 1, wherein the multispectral measurement system comprises at least one illumination source and a multispectral detector, wherein the at least one illumination source emits visible light radiation and ultraviolet radiation, and wherein the multispectral data comprises visible light spectral information and ultra violet spectral information.

23. The non-contact multispectral measurement device of claim 1, wherein the measurement device comprises a mobile communications device.

24. The non-contact multispectral measurement device of claim 1, wherein the measurement device comprises a dedicated color measurement device.

25. The non-contact multispectral measurement device of claim 1, wherein the position measurement system is selected from the group consisting of: a pattern projector and a camera, a camera autofocus system, a stereo vision system, a laser range finder, and a time of flight distance sensor.

26. The non-contact multispectral measurement device of claim 1, wherein the means to correct values output from the multispectral measurement system based on values provided by the position measurement system comprises:
a processor configured with instructions stored in a non-volatile memory that, when executed, cause the non-contact multispectral measurement device to:
operate the position measurement system to obtain a distance and an angular orientation of the multispectral measurement system with respect to the surface of interest;
operate the multispectral measurement system to acquire multispectral data corresponding to the surface of interest; and
correct the acquired multispectral data for the distance and orientation of the multispectral measurement system with respect to the surface of interest to produce position-corrected multispectral data.

27. The non-contact multispectral measurement device of claim 1, wherein the reflectance properties of the surface of interest include visible color information.

28-57. (canceled)
